(19) United States
(12) Patent Application Publication
(10) Pub. No.: US 2017/0011406 A1
(43) Pub. Date: Jan. 12, 2017

(54) Sound-Directed or Behavior-Directed Method and System for Authenticating a User and Executing a Transaction

(71) Applicant: NXT-ID, Inc., Shelton, CT (US)

(72) Inventors: Andrew Tunnell, Palm Bay, FL (US); Sean Powers, Melbourne, FL (US); David Tunnell, Palm Bay, FL (US); Jacob Zurasky, Orlando, FL (US)

(21) Appl. No.: 15/040,984

(22) Filed: Feb. 10, 2016

Related U.S. Application Data
(60) Provisional application No. 62/114,357, filed on Feb. 10, 2015.
(60) Provisional application No. 62/188,684, filed on Jul. 5, 2015.

(51) Int. Cl. G06Q 20/40; H04L 29/06; H04W 12/06; H04L 9/14

(52) U.S. Cl. CPC G06Q 20/40145; H04L 9/14; H04L 63/0861; H04W 12/06; H04L 63/107; H04L 2209/56; H04L 2209/80

(57) ABSTRACT

A method for executing a transaction. A first processing device senses a sound, an action, or a behavior from a source and receives identification information from the source, which may be related to or a portion of the sound, action or behavior. The first processing device processes one or more of the sound, the action, and the behavior and the identification information to identify the transaction and to identify the source. Executing the transaction if the source is an authorized source.

### CROSS-REFERENCE TO RELATED APPLICATIONS

The present application claims priority, under 35 U.S.C. 119(e), to the provisional patent application filed on Feb. 10, 2015, assigned application No. 62/114,357, and entitled Voice-Directed Payment System and Method, which is incorporated herein.

The present application also claims priority, under 35 U.S.C. 119(e), to the provisional patent application filed on Jul. 5, 2015 and assigned application No. 62/188,684, entitled Behavioral-Directed Authentication Method and System, which is incorporated herein.

### FIELD OF THE INVENTION

The present invention relates to the general field of executing a transaction, such as a financial transaction, a purchase transaction, reward transaction and the like. More particularly, the present invention relates to the technical field of using sound-directed techniques or behavior-directed techniques to authenticate, to identify and/or select information related to the transaction to be executed, to execute the transaction, or any combination thereof.

### BACKGROUND OF THE INVENTION

Most payments today are typically performed by a user selecting a payment method from a wallet. A user generally selects from a plethora of payment cards such as credit, debit, gift, or some other payment means such as cash. Other, more advanced prior art identifies the user as well as authorizing the payment action. WO 2011163071 A2 is one such method where biometric information collected from a user is matched with data stored in a biometric database. A biometric match then authorizes payment to a vending machine specifically. Applications of this type typically regulate the sale of restricted products such as alcohol to consumers whose biometrics match the required regulatory standards mandatory for purchasing such items at specific locations such as vending machines.

Many prior art patents and published patent applications describe the use of voice-directed access to a telecommunication network and the use of voice for biometric authentication of the user.

U.S. Pat. No. 8,938,402 describes a system using a smart token with a digital certificate that authenticates with a server on a network to execute a transaction on the network.

U.S. Pat. No. 8,938,070 describes the use of real world objects for use as encryption keys.

U.S. Pat. No. 8,938,052 describes a technique for allowing a user to execute structured voice commands to display visual information for items such as geographical navigation and messaging. Alternatively the system can be used to convert visual display information into structured speech, such as reading emails and text messages.

U.S. Pat. No. 6,081,782 allows a user to execute voice commands over a telecommunications network after being successfully identified by some action such as the entry of a series of digits or the phone number of the called party. Once identified, the user's voice commands are matched against stored values for authentication purposes. The system then allows the user to perform separate voice directed actions such as “Call Home.”

U.S. Pat. No. 8,655,789 authorizes financial transactions using a non-traditional device including an RFID device that remains inactive until the user authenticates himself/herself to the device using biometric data.

U.S. Pat. No. 8,694,315 allows for the use of a user configurable device to update a server-side fraud model for that user's financial account. Authentication of the user is based on both a match score indicating how closely the captured voice samples match to previously captured samples and a pass or fail response indicating whether the voice sample is an accurate reproduction of the word string the user was prompter to speak.

US published patent application 2013/0232073 allows a user's device, configured with various biometric sensors to authenticate the user, to provide proof to the payment processor for a payment from a single account.

Likewise, several prior art patents and published patent applications describe the use of gestures to perform authentication prior to performing a translation. US published patent application 20110282785 describes using a gesture to authenticate a user prior to accessing any payment data for transmission over near field communication (NFC). Under this patent, a user is required to make a user-defined gesture above a touch sensitive area on a “target” device to gain access to payment information on a wireless device. Access to the payment information is authorized if the gesture matches the recorded user-defined gesture. U.S. Pat. No. 8,913,028 also describes a gesture-based method, but describes a “tactile” force as well to take a mobile device or a non-transitory computing device from a first state to a second state specifically to change a unlocked state or a music playlist. US published patent application 20140064566 authorizes access to payment information from a gesture captured by means of a camera.

US published patent application 20150019432 utilizes motion of a mobile device to authorize a payment. Prior art of this type typically uses a device to detect a particular gesture through sensors such as a gyroscope within the mobile device. A signal is then sent to a passive device using a peer-to-peer connection. Similarly, CA 2860114 A1 utilizes a device containing gesture-detecting sensors including an accelerometer, a video camera, or a magnetic field sensor. Once a gesture is received from the user on the mobile device, it is sent to a hub. US published patent application 20140300540 describes a mobile device used to capture a user gesture, which is then translated into a coefficient. In this prior art, a gesture is detected from movement of the mobile device and specifically associated with accounts online, over a network, susceptible to attack.

Similar to US published patent application 20140300540. US published patent application 20110251954 uses a touch gesture captured on a mobile device to access a specific online financial account to make a payment. Likewise, US published patent application 20100217685 uses a user based gesture to make a “commerce-related action” in a “networked environment”.

In CN 103268436 A, a gesture is used to make a payment at a given payment terminal. Described in US published patent application 20120330833 is a method wherein a user inputs a gesture which is then used in correlation with an image of the user captured by a camera to identify the user with a specific account that may be used to make a transaction at a terminal including a POS system.

EP 2690850 A1 describes information sent from one device to another with a throwing like gesture. Herein, when a user wants to send information, he or she will take the first device and make a throwing gesture with that device in the direction of the receiving device.

US published patent application 20120324559 describes a user gesture received by a first device, which extracts features, then translates those features into a token. The token is then sent to a second electronic device, which can either derive another token from the original token, or use the original token. Finally, the secondary electronic device will send the token (either the original or the reproduced) to a server.

WO 2014041458 A1 describes a mobile system that is used to make payments in a mobile currency while utilizing a mobile account to generate a barcode containing the payment information. In some embodiments, a gesture “of any body part” is utilized to access a mobile account.

Most prior art consists of a single biometric or gesture authenticating the user to allow access to financial data or payment data. Some prior art describes methods to access data to send to a mobile device, hub or remote server to authenticate and execute a payment. Several implementations utilize one or more online services to perform authentication and approval for a transaction. Most prior art consists of the gesture unlocking access to all accounts, but not to a specific account selectable from a multitude of accounts. Such biometric and gesture-based prior art is simply serving as a “graphical password” to access and/or execute payment, not to select as well as authorize a payment.

### SUMMARY OF THE INVENTION

No known prior art utilizes a biometric or behavior to both authenticate a source and transaction by associating the behavior to a specific account from among multiple accounts such that the sound or behavior of a source selects the account and executes a transaction, all based on the biometric or behavior. Prior art is not tied to a specific account, but allows wireless communication of accessed payment data associated with a biometric or gesture (both singular). The more difficult, non-obvious challenge is to match multiple biometrics and/or behaviors to specific transaction information such as selecting an account from multiple accounts, as a non-limiting example, so that each biometric or behavior performed by a source selects the transaction as well as authenticating the source with the same biometric or behavior. This challenge is further exacerbated as each instance of biometrics and behaviors are not always identical. Interpretation is based on statistical modeling that does not result in the same array of a specific number that can be matched with cryptographic devices or compared to other numbers.

As the number of transactional accounts increases, so does the complexity of matching multiple behaviors from biometrics and behaviors to multiple specific numbers or cryptographic keys typically used with authentication and access control. What is needed is a sophisticated method to reliably detect and recognize multiple biometric and gesture behaviors in a manner that can be consistently compared to multiple numbers and/or cryptographic keys as well as associated with specific payment accounts from multiple payment accounts, completely selectable and under the owners full control whether local on a device or remotely online.

In this invention, one or more devices may both authenticate a source and/or direct a transaction at the same time. Transactions are “directed” by selection of information associated with a transaction via sound or behavior from a source, or combinations of both.

Embodiments of this invention disclose systems and methods to direct a financial transaction (such as but not limited to making a payment) using a sound or behavior recognition technique. One aspect of the invention combines the advantages of recognition with the execution of a transaction, such as executing an electronic payment using sound-directed or behavior-directed inputs. Generally, a source may generate a sound or behavior that is associated with a specific transaction information, thereby choosing or selecting transactional information from multiple transactional information.

Using voice as a non-limiting example, Hidden Markov Models (HMMs), as a non-limited example, may be used to model users' speech utterances. Markov models are randomly changing systems where it is assumed that future states depend only on the present state and not on the sequence of events that preceded it. Speech can be modeled using HMMs since a speech signal can be viewed as short-time stationary signal when using a time-scale of ten to thirty milliseconds, but HMMs are also applicable to other information and authentication approaches as well.

Models are trained to estimate the parameters for the HMM. The parameter learning task in HMMs is to find, given an output sequence or a set of such sequences, the best set of state transition and emission probabilities. More training data available during the parameter learning task results in the model being more likely to accurately classify a user's utterance. The values stored in the model file can classify or separate the trained data (or data like it) from other ‘non-trained’ data (or data not like it).

Within this non-limiting example, a model may be trained to only understand voice of one specific individual. As features are extracted from utterances collected by the user saying the same word repeatedly, feature data is run through the algorithm, such as but not limited to a Baum-Welch algorithm, to derive the maximum likelihood estimate of the parameters of the HMM. The HMM can then be used to classify the trained users' speech. The model also can be re-trained, or adapted with more user utterance data to further improve its classification results.

This same model methodology may be applied to recognize behavior as well as biometrics such as voice.

Recognition models may be located remotely on a server or cloud or locally on a device. Devices may comprise one or more personal computers, laptops, tablets, dongles, servers, mobile, wearable, or any non-transitory memory. In some embodiments, the acoustic and behavior recognition models may also be distributed to one or more devices, that in turn direct one or more transactions on the same or different one or more devices.

“Transaction information” is defined herein as any information that may be associated with an account, name, number, price, bank number, routing number, credit card number, debit card number, gift card number, loyalty or reward number and the like, or in some embodiments, payment method to be performed. Transaction information may also include but not be limited to an alias to any information associated with a transaction.

Payment methods may include but are not limited to magnetic stripe, wireless magnetic stripe, EMV (EuroPay, MasterCard, Visa), NFC (Near Field Communication), WiFi, Bluetooth, BLE (Bluetooth Low Energy), PAN (Personal Area Network), sound, light, RF (Radio Frequency), and the like collectively called “payment methods” hereafter.

This invention directs the transaction by interpreting a sound or behavior, performed by the source, wherein that sound or behavior selects transaction information and, in some embodiments, executes the transaction.

Anything that can perform a sound or behavior is referred to collectively as a “source herein, including but not limited to a user, device, object or “thing” within the “Internet of Things (IoT)”.

A sound as referred to herein includes any vibration disturbance that generates pressure waves through a medium, where the waves have an auditory effect upon reaching a sound receiver, such as but not limited to an ear, a sensor, a microphone or a transducer and the like that perceives the sound. Such sounds may include but are not limited to noises, voice, vocal utterance, musical tone words, phrases, whistles, clicks, claps, musical tones, a non-word sound such as humming or grunting, any type of human-generated sound, or virtually any sound that a source can generate, either with or without the aid of a separate sound-generating device and the like. Sound may be generated by a person or generated by one or more objects and either generated automatically or under control of a person. It is not necessary that a sound referred to herein be within the audio frequency range of a human being. These vibrational disturbances are collectively referred to herein as “sounds” and according to the present invention, may operate as “aliases” as described elsewhere herein.

A behavior referred to herein comprises any action, gesture, movement, or position or movement of a user's finger, hand, arm, body, head, face, and the like. Each behavior comprises a single or a plurality of action elements including but not limited to angle, position, direction, speed, number, tapping, depressing, clicking, swiping, orientation, or combinations of each and the like may be interpreted as a behavior. In certain embodiments these action elements or portions of action elements, in lieu of the complete action, are analyzed. Such actions or gestures are referred to as behaviors herein.

Any behavior by an individual or object may be sensed and/or interpreted by any number of sensors including but not limited to one or more accelerometers, gyros, optical, RF (Radio Frequency) and the like, while sounds may be detected by any acoustic, vibration, transducers, sound or voice collection devices, collectively referred to as “sensors” hereafter.

In some embodiments, the source is authorized to make a transaction based on the sound or behavior. In another embodiment, the source is authenticated by one sound or behavior, while a subsequent sound or behavior directs a transaction. In other embodiments, the source is authenticated by the same sound or behavior that directs the transaction. In yet another embodiment involving a sound or behavior recognized by one or more devices while directing a transaction on one or more other devices.

### BRIEF DESCRIPTION OF THE DRAWINGS

FIG. 1 illustrates a exemplary pattern drawn by a user to direct a transaction or identify the user.

FIG. 2 illustrates an alias used to access a device and execute a transaction.

FIG. 3 illustrates the use of features, scores and PINS to identify an account.

FIG. 4 illustrates mapping a Hidden Markov Model network score(s) to a dictionary letter.

FIG. 5 illustrates multiple devices training a common acoustic model.

FIG. 6 illustrates use of additional factors in correlation with sound during recognition.

FIG. 7 illustrates one sound used to gain access to a device, while second and third sounds are used to gain access to specific accounts and parameters.

FIG. 8 illustrates a first sound producing a score, which is then incorporated into subsequent scores based on other sounds.

FIG. 9 illustrates one device performing authentication of a user using sound recognition, while another device executes a transaction associated with that sound.

FIG. 10 illustrates a device sending an action code to a POST and the POST routing the action code to another device to access a specified account.

FIG. 11 illustrates a user speaking to a POS system with the POS system extracting sound features and sending the features to a device for recognition and authentication of the user for the purposes of accessing a specified account.

FIG. 12 illustrates one device receiving a sound input and distributing that input to multiple devices for use during various stages of processing.

FIG. 13 illustrates multiple devices receiving a sound simultaneously.

FIG. 14 illustrates the user of multiple accounts and portions of accounts are used to make a single payment.

FIG. 15 illustrates a single device performing authentication of the user and execution of the transaction.

FIG. 16 illustrates the use of geographical limits to regulate authentication of a user.

FIG. 17 illustrates one embodiment of the present invention wherein a group of information represented by a “voice card” may be accessed by entering a specific sound.

FIG. 18 illustrates multiple devices simultaneously authenticating (based on a sound) and sending pieces of information to a single device to form a complete voice card.

FIG. 19 illustrates a single device containing a complete voice card authenticating a user, after which the device requests access of the voice card by other devices.

FIG. 20 illustrates a single device performing sound recognition and sending action codes to multiple devices requesting access to pieces of a voice card located on the multiple devices.

FIG. 21 illustrates use of a previous score for accessing one piece of information from a voice card and for producing the next score for accessing the next piece of information.

FIG. 22 illustrates recognition of multiple factors from a single sound.

### DETAILED DESCRIPTION OF THE INVENTION

Before describing in detail the particular methods and apparatuses related to a sound-directed or action-directed method and system for use in authenticating and performing a transaction, it should be observed that the embodiments of the present invention reside primarily in a novel and non-obvious combination of elements and method steps. So as not to obscure the disclosure with details that will be readily apparent to those skilled in the art, certain conventional elements and steps have been presented with lesser detail, while the drawings and the specification describe in greater detail other elements and steps pertinent to understanding the embodiments.

The presented embodiments are not intended to define limits as to the structures, elements or methods of the inventions, but only to provide exemplary constructions. The embodiments are permissive rather than mandatory and illustrative rather than exhaustive.

This invention discloses a system and method to direct one or more financial transactions (such as making a payment) using one or more sound or behavior recognition techniques. One aspect of the invention combines the advantages of recognition with the execution of a transaction, such as executing an electronic payment using sound-directed or behavior-directed inputs.

Generally, a source may generate a sound or behavior that is associated with a specific transaction information. Sound and behavior may be recognized using mathematical models. Using voice as a non-limiting example, Hidden Markov Models (HMMs), as a non-limited example, may be used to model users' speech utterances. Markov models are randomly changing systems where it is assumed that future states depend only on the present state and not on the sequence of events that preceded it. Speech can be modeled using HMMs since a speech signal can be viewed as short-time stationary signal when using a time-scale of ten to thirty milliseconds, but HMMs are also applicable to other information and authentication approaches as well.

Models are trained to estimate the parameters for the HMM. The parameter learning task in HMMs is to find, given an output sequence or a set of such sequences, the best set of state transition and emission probabilities. More training data available during the parameter learning task results in the model being more likely to accurately classify a user's utterance. The values stored in the model file can classify or separate the trained data (or data like it) from other ‘non-trained’ data (or data not like it).

Within this non-limiting example, a model may be trained to only understand voice of one specific individual. As features are extracted from utterances collected by the user saying the same word repeatedly, feature data is run through the algorithm, such as but not limited to a Baum-Welch algorithm, to derive the maximum likelihood estimate of the parameters of the HMM. The HMM can then be used to classify the trained users' speech. The model also can be re-trained, or adapted with more user utterance data to further improve its classification results.

This same model methodology may be applied to recognize behavior as well as biometrics such as voice.

Recognition models may be located remotely on a server or cloud or locally on a device. Devices may comprise one or more personal computers, smart cards, smart watches, jewelry, wallets, laptops, tablets, dongles, servers, mobile, wearable, or any non-transitory memory. In some embodiments, the acoustic and behavior recognition models may also be distributed to one or more devices, that in turn direct a transaction on the same or different one or more devices.

In this invention, one or more devices may both authenticate a source and direct a transaction at the same time. Transactions are “directed” by selection of information associated with the transaction via sound or behavior from a source, or combinations of both.

“Transaction information” is defined herein as any information that may be associated with an account, financial, payment, loyalty, or other account owned by a user, or in some embodiments, an alias that represents an account, name, number, price, bank number, routing number, credit card number, debit card number, gift card number, loyalty or reward number and the like, or in some embodiments, payment method to be performed. Transaction information may also include but not be limited to an alias to any information associated with a transaction.

Payment methods may include but are not limited to magnetic stripe, wireless magnetic stripe, EMV (EuroPay, MasterCard, Visa), NFC (Near Field Communication), WiFi, Bluetooth, BLE (Bluetooth Low Energy), PAN (Personal Area Network), sound, light, cellular communications such as 3G/4G/LTE, RF (Radio Frequency), and the like collectively called “payment methods” hereafter.

This invention directs the transaction by interpreting a sound or behavior performed by the source that selects transaction information and, in some embodiments, also authenticates the source and/or executes the transaction.

Anything that can perform a sound or behavior is referred to collectively as a “source” herein, including but not limited to a user, device, object or “thing” within the Internet of Things (IoT)”.

A sound as referred to herein includes any vibration disturbance that generates pressure waves through a medium, where the waves have an auditory effect upon reaching a sound receiver, such as but not limited to an ear, a sensor, a microphone or a transducer and the like that perceives the sound. Such sounds may include is not limited to noises, voice, vocal utterance, musical tone words, phrases, whistles, clicks, claps, musical tones, a non-word sound such as humming or grunting, any type of human-generated sound, or virtually any sound that a source can generate, either with or without the aid of a separate sound-generating device and the like.

Sound may be generated by a person or generated by one or more objects and either generated automatically or under control of a person. It is not necessary that a sound referred to herein be within the audio frequency range of a human being. These vibrational disturbances are collectively referred to herein as “sounds” and according to the present invention, may operate as “aliases” as described elsewhere herein.

A behavior referred to herein comprises any action, gesture, movement, or position or movement of a user's finger, hand, arm, body, head, face, and the like. Each behavior comprises a single or a plurality of action elements including but not limited to angle, position, direction, speed, number, tapping, depressing, clicking, swiping, orientation, or combinations of each and the like may be interpreted as a behavior. In certain embodiments these action elements or portions of action elements, in lieu of the complete action, are analyzed.

Any behavior by an individual or object may be interpreted by any number of sensors including but not limited to motion sensors, image sensors, and/or cameras, as well as device movement detection devices such as but not limited to accelerometers and gyroscopes, optical, RF (Radio Frequency) and the like, while sounds may be detected by any acoustic, vibration, transducers, sound or voice collection devices, collectively referred to as “sensors” hereafter.

Some embodiments include techniques wherein specific aspects of the movement of behavior are detected and used for feature extraction. Such aspects include not only the features from the motion of the body part, but also the physical features of the body part itself. Features and/or measurements of motion include but are not limited to the speed of the movement, the direction of the movement, and the intervals of speed of the movement.

Features, measurements and the like that characterize behavior are referred to as “behavior metrics” hereafter since they serve to discriminate distinctive characteristics of an individual to prove identity (something you are) as well as behavior control (something you know). Physical aspects may include but are not limited to the dimensions, width, height, length, volume, size, area, or in the case of a touch interface to detect behavior, the pressure of a finger tip, hand, or other body part.

A non-limiting example of intervals of speed may include but is not limited to a user makes a circular motion with his or her finger. The speed of a finger may be consistently different at different portions of the motion throughout the course of the entire motion. These different “intervals of speed” may be used as specific data sources for feature extraction during training and authentication. As another example, a user may draw in space with his or her hand or a device the letters V I S A or G A S to select a specific payment while the parameters detected to draw these letters are uniquely identified and associated with a source and/or transaction.

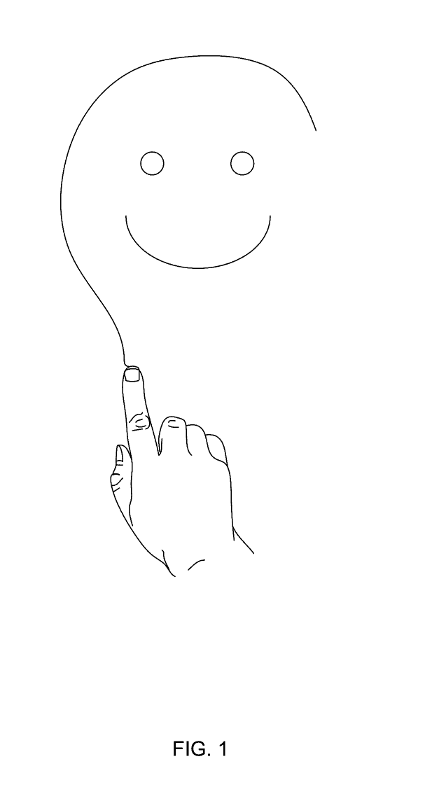

Similar to gestures, patterns are behavior biometrics that can be detected from sensors such as but not limited to touch screens and/or capacitive, resistive, infrared or other touch detection sensor technologies. Under such embodiments, a user may simply touch or draw a pattern to direct a payment as shown in FIG. 1. Various parameters of the pattern are detected such as but not limited to the size, intensity, speed and direction as the user draws the pattern.

In one non-limiting example a user may utilize his or her finger to make a gesture on a touch screen device. Herein different aspects of the sources pattern can be utilized for authentication. These aspects include but are not limited to aspects of motion such as but not limited to the direction of the gesture, the speed of the gesture, or the pressure of the finger on the receiving device. Physiological aspects of the gesture that might be measured include but are not limited to the dimension; width, height of the finger; the size; volume of the finger; the print made by the finger itself and the like. In one non-limiting example, a user may make a behavior with his or her finger in a circular motion on a touch screen device. Different aspects of the gesture will be captured and used for risk scoring, such as the direction of the motion, the pressure applied to the screen, the speed of the behavior (as a whole and throughout different intervals of the motion), and the finger print that the user made when drawing.

Likewise, voice biometrics are unique in that they can convey both identification (something you are) as well as a secret (a word or sound that you know).

A key advantage of these sound and behavior methods and systems is that they enable accessibility to those that may have some disability such as but not limited to sight impaired. Sound and behavior biometrics also enable users to quickly direct a payment, choose and account and/or payment method and/or payment amount by simply generating a sound or performing a behavior that is associated with the specific payment account, payment method and/or amount, as a non-limiting example.

In yet another method of the present invention, facial expressions may be utilized as behavior for authentication and/or directing a transaction. In some embodiments, two or more facial expressions may be used in correlation with one another to authenticate a user. Facial expressions may include pose, expressions, blinking rate and number of blinks of the eyes, and related changes to the face caused by a user's behavior. Purposeful changes to the face may be associated with a specific account and/or payment method, while also serving for recognition of the user. Thus, this behavior biometric may be used to direct a payment.

Different aspects of a user's facial expression may be utilized to recognize the source. Such aspects may include but are not limited to the extent to which a source moves a certain part of his or her face and how the user moves his face or a certain part of his or her face. Other aspects may include but are not limited to physiological features such as the dimensions of a user's face. In some non-limiting embodiments, the distance between the user's face and the entity receiving the data may be taken into account and used for risk scoring. However, in other embodiments, the distance between the user's face and the entity receiving the data may not be taken into account at all.

Voice or a sound made by a source may also be used for purposes of authentication. Different aspects of the sound or voice may be taken into consideration. Such aspects include but are not limited to the pitch of the voice or sound, the frequency of the voice or sound, the speed with which a user says or makes a sound, and the intervals of speed during the course of the voice or sound, as well as other characteristics of the sound. The intervals of speed are defined herein as the speed with which each dimension of the sound is produced. Dimensions may include but are not limited to the syllables or the frames of the captured audio.

In some embodiments, the source is authorized to make a transaction based on a sound or behavior. An example of such embodiments includes but is not limited to a credit card associated with the sound or behavior is selected and used to may a payment. In a related embodiment, an NFC payment method associated with the recognized sound or gesture executes the payment.

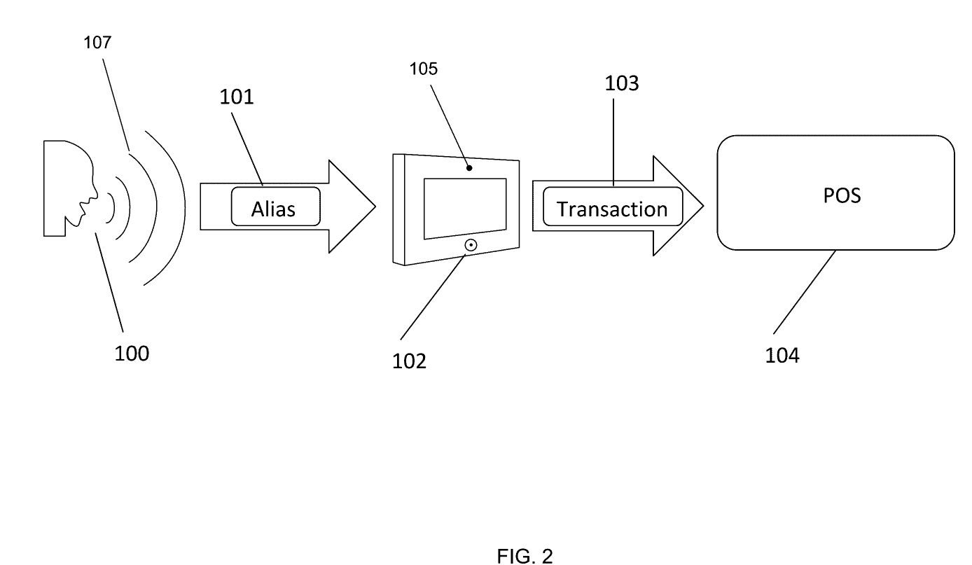

FIG. 2 illustrates how a source 100 can access one or more accounts by emitting a sound or behavior that is associated or an “alias” 101 that represents certain predetermined transaction information 103, such as but not limited to an account, without disclosing that information. In this example, the sound 107 is associated with an alias that is input to one or more sensors 105 on one or more devices 102. Not only does use of the alias 101 allow for easy access to an account, the alias 101 also gives the source 100 confidence in the security of the transaction 103 to be executed, since virtually no personal information is transferred to the device 102 to effectuate the transaction 103. In this example the transaction 103 is executed by a POS (Point of Sale) system 104 responsive to transaction related details supplied by the device 102 to the POS 104. Generally, those details are provided in coded or encrypted form and therefore not easily decoded or interpreted.

Depending on the application of the present invention, in other embodiments, the alias can identify a product brand or the name of a company, a specific location, or a specific transaction to be executed.

In another embodiment, the source is authenticated by one sound or gesture, while a subsequent sound or gesture directs a transaction. An example of this embodiment would include a sound or gesture recognized by a smart card to access the card, followed by a sound or gesture that directs a transaction. In a related embodiment, the second sound or gesture may also be associated with BLE payment method local on the smart card, for example.

In other embodiments, the source is authenticated by the same sound or gesture that directs the transaction. Here, a laptop, as a non-limiting example, is accessed as debit card information is used to perform a transaction by recognizing a sound or gesture, or combination of both. In a related embodiment, the sound or gesture is related to non-specific payment method such that the transaction may be execute via Bluetooth or WiFi, for a non-limited example.

In yet another embodiment involving two or more devices, a sound or gesture recognized by one or more devices while directing a transaction on one or more other devices. Under this embodiment, a cell phone as a non-limiting example, may recognize a sound or gesture and direct a transaction via two other devices, a smart card and a smart watch for a non-limiting example. Under this example, a smart card may support multiple payment methods including EMV, magnetic stripe, wireless magnetic stripe, Bluetooth or BLE (Bluetooth Low Energy), NFC, WiFi, and the like, while the smart watch may only support NFC. Two or more devices may be authenticated with one another in order to pass transactional information across an interface between the devices securely and execute the transaction. Once executed, the devices may communicate with one another to validate the transaction took place, or in some embodiment, pass information such as the charge amount back to one or more of the other devices.

In a case where the sound is voice-based, the voice recognition acoustic models may be trained for either speaker dependent or speaker independent recognition.

A speaker-dependent acoustic model is an acoustic model that has been trained to recognize a particular person's speech, i.e., determining that a specific person has made the sound and thereby identify the person. These speaker-dependent models are trained using audio from a specific person and can identify a speaker extracting features from the presently made sounds and statistically comparing them with the maximum-likelihood feature vectors stored in the acoustic model. Further, if the processing device contains a list of authorized users (for example those users who are authorized to use a device or authorized to access a financial account) once the model identifies the user (by name or by another identifier) the device can determine if the users name or identifier appears on the list of authorized users.

A speaker-dependent model can more accurately identify the person if he/she makes a predetermined sound that has been acoustically trained into the acoustic model, rather than if he or she makes any random sound.

Such speaker-dependent models may also recognize non-word human-generated sounds since they are generated by an individual's vocal chords, which have unique physical characteristics and thus impart unique and detectable biometric characteristics to the non-word sounds. Even sounds emitted by a robot can be distinguishable if emitted with specific characteristics.

A speaker-independent acoustic model may interpret sound from any person, including those who did not submit any audio samples for use by the acoustic model. In the context of some embodiments of the present invention, a sound processed through a speaker-independent model operates as an authorization code (e.g., a pass code or a password) to authenticate the source.

In either case of the speaker-dependent acoustic processing or the speaker-independent acoustic processing, the sound may facilitate not only authorize/authenticate the user, but also authorization and execute a transaction to be conducted by or for the source. Exemplary transaction include granting the user access to a financial account or supplying the user with information. The specific account to be accessed and the specific information to be supplied may also be identified in the sound or another sound may be required to identify the account or the information.

In one embodiment of the invention (referred to as a speaker-independent model embodiment) a speaker independent acoustic model is used to analyze a sound. A processing device incorporating the speaker independent model need only determine if the source generated the correct sound. In some embodiments, if the correct sound was made, then the processing device uses the same sound to identify the transaction that the user wants to conduct. If the transaction involves a financial account, for example, then the processing device accesses that account, allowing for the user to execute a transaction in a short period of time by either performing a behavior or making a sound.

In a more secure embodiment (referred to as a speaker dependent model embodiment), the processing device utilizes a speaker-dependent acoustic model to identify the speaker and based on that identification determine whether the user is authorized to conduct a transaction on the device. The type of transaction or details of the transaction are also determined from the sound. If the source is an authorized source, then the processing device can conduct the transaction.

In many electronic financial transactions, users frequently identify themselves using a code or a “PIN” (personal identification number). PINs are personal identification numbers that are frequently associated with financial services to authenticate access (something you know). However, under some embodiments of this invention, PINs may also identify both an individual and account and/or payment method by associating the PIN to the user, account and/or payment. In addition, PINs may be called “behavior biometrics” if they can detect the way the user enters data, such as with dynamic PIN implementations.

This invention introduces the concept of generating codes or numbers from specific behavior. In some embodiments, these behavior codes are generated from recognition scores and associated to a specific dictionary letter. The dictionary may also be changed, in some embodiments. Behavior codes are referred to as “Behavior PINs” hereafter.

In some embodiments, a PIN entered by a user is recognized to direct a payment. In other embodiments, an expression such as a facial expression is translated to an “expression PIN” to direct a specific account and/or payment method. Behavior PINs are unique identifiers derived from behaviors that are recognized by an individual and translated into specific alphanumerical codes by unique scoring methods.

In yet another embodiment, a biometric such as voice or sounds are recognized and translated to a “voice pin” to direct a payment. Other embodiments include “gesture PINs” where payment is directed from user movement such as but not limited to waving a device in a specific manner and “pattern PINs” where specific accounts and/or payment methods directed by a user drawing a pattern on a device such as but not limited to a touch screen.

In all these embodiments, multiple features are extracted to uniquely identify the user as well as the gestures, pattern, expression, word, sound or other salient features that may be associated with an account or payment method.

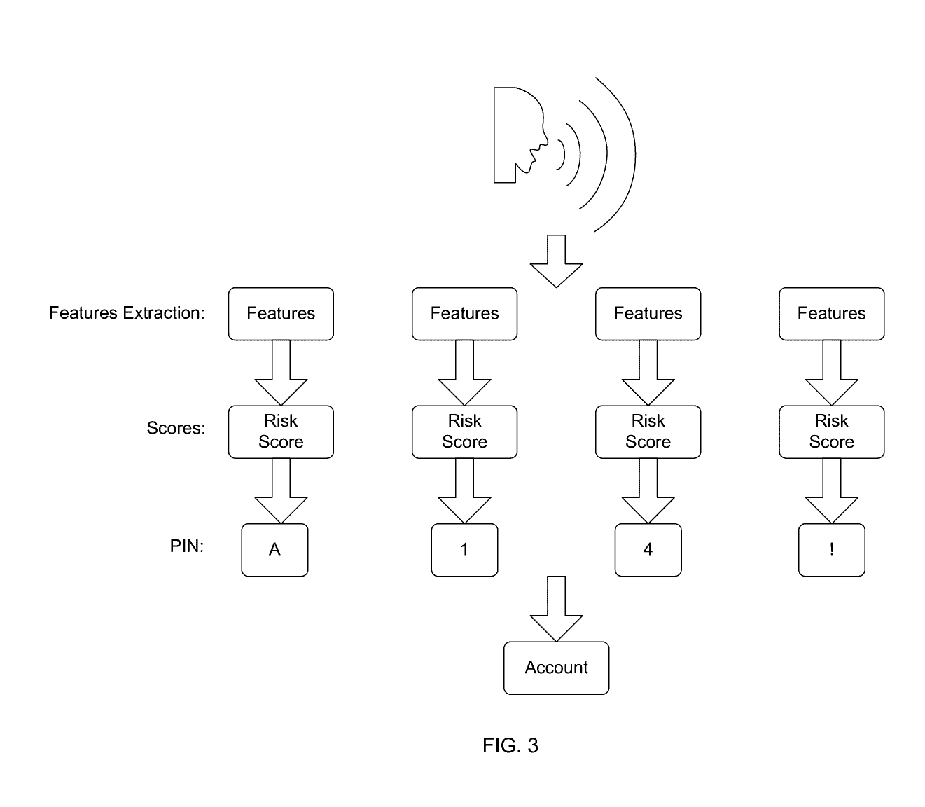

PINs are generated from risk scores performed on segments of detected sound or behavior. When a specific sound or behavior is detected, feature extraction is applied to each frame, state, or dimension of detected behavior. The feature sets are then converted into risk scores. Risk score ranges are used to match each risk score to a specific character as shown in FIG. 3. Based on these ranges, each risk score is interpreted as a given character, producing a code such as but not limited to a PIN. The PIN produced is matched with a recorded PIN to authenticate the user. In embodiments such as this, behavior can be matched to fixed, inflexible cryptographic keys within cryptographic devices, which in turn, may be used to select a particular account or other information associated with a transaction as shown in FIG. 3.

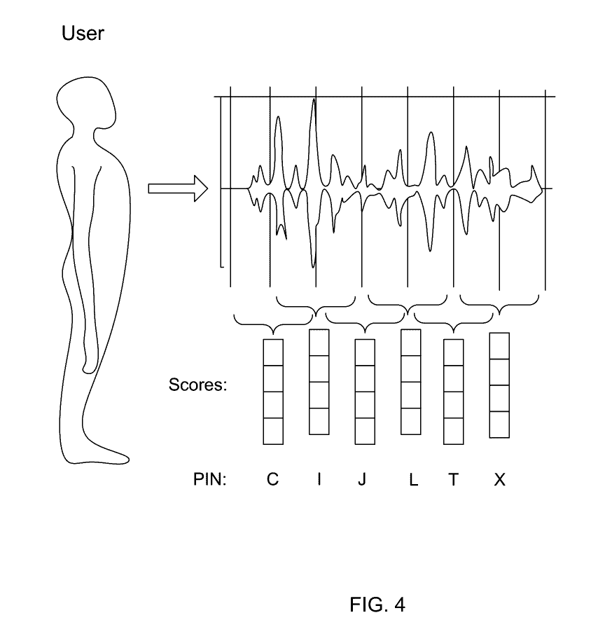

Under one embodiment, every n frames map a current HMM (Hidden Markov Model) network score(s) to a dictionary letter. Each letter will be defined as a range of values. Examples include A [0-10], B [10-20], C [20-30], etc. as shown in FIG. 4. Each spoken utterance will provide a consistent code, passcode and/or “PIN”. The user that trains the models' PIN will be used as an encryption key. Under such embodiments, the PIN will depend on the scores of the HMM network(s) and not on the static model values. Different sources generating the same utterance will result in a different PIN because the runtime scores will differ.

Those experienced in the art will readily recognize the basic concepts of authentication such as feature extraction in the front end and risk scoring in the backend. During training, in the method described herein, features are first extracted from the each of the separate frames, states, or dimensions of a given input. After feature extraction, risk scores are then derived at intervals of the behavior. Each risk score is then correlated to a certain representation of the risk score. Such representation of risk scores will hereafter be referred to as risk score representation. Representations of risk scores can include but are not limited to letters, numbers, or symbols. This is accomplished by utilizing a range including but not limited to a risk score range. Each risk score range has a correlating representation. When scores are produced, each one will fall into their separate and designated risk score ranges. Each risk score will then be assigned a representation based on the risk score range. The result of this process is a character representation including but not limited to a (PIN) personal identification number.

During authentication, the user will enter his or her gesture into one or more given devices. Devices can include but are not limited to laptops, cellphones, smart wallets, tablets, or smart watches. One or more of frames, states, or dimensions or as in some embodiments, a combination of such will go through feature extraction. After feature extraction has been executed, the features will be transformed into risk scores. Each risk score will then be matched with its respective letter, symbol, or number, forming a PIN. The PIN will then be matched with the PIN that was captured during training. In some embodiments, the user will be authenticated if the PIN exactly matches the PIN that was recorded during training, while in other embodiments the PIN required for authentication may entail a range of values.

In one non-limiting example of how a source is authenticated, a source, such as a user, may speak or gesture into a mobile device such as but not limited to a smart wallet. First, feature extraction will be performed on the gesture data received. After feature extraction has been executed, risk scores will then be generated from one or more of the given pieces of information: frames, states, or dimensions. Each risk score is then translated into its given representative number, letter, or symbol during risk score representation. Resulting is a representation of the sound or gesture received, which may be in the form of a PIN.

In some embodiments, the risk score range may be predefined as determined during training. Other embodiments consist of a technique wherein the risk score range is calculated by means including but not limited to one or more given algorithms. In some embodiments, the risk score range may change as determined by the one or more given algorithms. One non-limiting example of where the risk score range would change would be with voice recognition of a given phrase or word. Yet another example of where a risk score range would change would be with the signature of a source. In both examples, the user may execute the gesture over time, thus causing the “movement” or the changing of the risk score range as calculated by the given one or more algorithms.

In one embodiment of the present invention, a source is able to access specific segments of information based on the gesture made. This is done by tying the PIN produced to the specific segment of information. Segments of information include but are not limited to financial accounts, passwords, games, apps, or other specific pieces of information. A non-limiting example would be a user accessing a bank account by a waving motion of his hand.

In some embodiments a user may emphasize or change the gesture to access a different portion of information. By changing the gesture, the user could access a completely different segment of information with a gesture that is almost identical except for one portion of the gesture known only to the user. One non-limiting example may include the user altering his or her voice to access a different account.

In yet another embodiment a user may select one or more certain portions of a segment of information. Such selected portions may include but are not limited to a one or more specified amounts within one or more accounts.

To demonstrate the versatility of transactions that can be executed from an interpreted sound or behavior, a spoken word or phrase or another sound (all collectively referred to herein as a “sound”) or some action, motion, gesture or the like (all collectively referred to herein as a “behavior”), is used to first authenticate the user to her mobile phone and second to indicate that the user wishes to place a telephone call. The second sound may also identify the person the user wishes to call or another sound may be required to identify the called party. Upon perceiving and interpreting the sound and determining that the user is an authorized user (using either a speaker dependent model or a speaker independent model) the phone authenticates the user and places the call to the person represented by the sound.

In another example, a first sound is first used to authenticate the user to a computing device (using either a speaker dependent model or a speaker independent model) and the first sound then causes a map of a region represented by the sound to be displayed. Then responsive to a second sound the device identifies a street on the map. In yet another example, a first sound authenticates the user to enter a controlled-access area, and also identifies and unlocks a door in the controlled-access area.

In one embodiment, the sound or behavior authenticates the user to a secure financial account and further identifies that account. The user can then execute a financial transaction in that account. Thus the sound or behavior serves the dual role of serving to authenticate the user to the account and also identify the account. The sound or behavior may also indicate the specific type of transaction the user wishes to execute, for example, making a payment against the identified account. In some embodiments, the same sound or a subsequent sound may also identify an amount of the transaction.

In another embodiment the sound is analyzed to authenticate a user to use a computing device and additionally identifies a website the user wishes to visit. The same sound or a different sound may then identify a product the user desires to purchase from that web site.

The authentication process may be conducted locally (e.g., solely on a device under control of or in possession of the source), remotely (such as on a server), or by a combination of both local and remote authentication processes. Devices that can perceive the user-generated sound, perform the authentication process based on that sound or action, identify, and perform the transaction desired by the user comprise any of the following: a digitally-based device, an electronic device, a mobile device, a wearable device, a smart wallet, a smart card, a processing device, and the like.

Interpreting the sound or behavior and the desired transaction can also be performed locally, remotely or through a combination of both local and remote processing operations.

The sound or behavior may not only identify the type of transaction (e.g., selected from a list of transactions), but also indicate details required to successfully conduct the transaction. For example, the sound (after used for authentication purposes) may first indicate a transaction involving a transfer of funds between two predetermined financial accounts and further indicate the amount of money to be transferred, or the sound may designate one or both of the accounts involved in the transaction.

In one embodiment, a user is first authenticated or authorized to access an account by analyzing the user's action or sound. The same action or sound is then used to select an account. The source may perform a financial transaction in that account manually or the financial transaction can be executed by the same action or sound or by a different action or sound.

According to this invention, in addition to being used for authentication/authorization, a sound or gesture also operates as an account identifier or authorization code for an account, a web site, an element of information, a person, a place or a thing, etc. But the sound or gesture is in fact an “alias” for the account identifier or authorization code. In one sense the alias is in fact an account identifier. That is, the source employs the alias associated with a specific sound and/or gesture that represents the identifier in lieu of identifying that account, web site or element of information, by name, number, etc.

The alias may include but is not limited to a sound, word, phrase, object, noise, action, gesture, vibration, touch related gesture, brain signal, speed, acceleration (such as driving a certain speed to make a payment) or phoneme.

In some embodiments, the alias may be combined with other gestures, sounds, words, numbers, PINS, passwords, biometrics, etc., to perform the user authentication process or to identify the transaction. In some embodiments, the alias may be combined with other gestures, sounds, words, numbers, PINS, passwords, biometrics, etc., to perform the user authentication process or to identify the transaction,

As described herein, several embodiments of the present invention use alias recognition to carry out specific transactions such as accessing accounts and executing transactions. Other embodiments use multiple aliases to execute multiple actions. Still other embodiments use multiple aliases to execute multiple actions during an identified time period. In still other embodiments, a first alias is used to grant access to an item, such as a smart wallet, while a second alias is used to gain access to an account accessed through the smart wallet. In yet another embodiment a third alias may be utilized to access a specific parameter, such as a payment amount for the transaction identified by the second alias. This third alias may identify a payment amount, for example. Through-speech-to text conversion, that amount may be displayed on a display screen.

Another aspect of the present invention consists of a method to use multiple aliases to increase the security of an authentication session. In such an embodiment, each alias is analyzed to produce a risk or confidence or recognition score indicative of the risk or confidence that the user has been properly authenticated based on the alias provided by the user. The sound received from the user as well the different characteristics of that sound and of it's given samples determine the risk score.

In some embodiments, this score may be incorporated into the score of the second, third, or fourth alias. As a non-limiting example, a source may utter the word “dog” to gain access to a device, resulting in the generation of a risk score for the word “dog.” Following this process, the user may then utter the word “cat” to gain access to an account. The risk score from the word “dog” may then be incorporated into the risk score of the word cat upon its generation. In one embodiment, different algorithms executing on a device (or on different devices) may determine separate risk/confidence scores. In yet another embodiment, these scores may be combined into a single score representative of the degree of certainty associated with the authentication process.

One embodiment consists of a method wherein risk/confidence scores are derived from the authentication process and the score determines specific elements of information and/or accounts to which the user can gain access, e.g., a higher confidence score permits access to more secure accounts.

The authentication process may comprise collaborative multi-factor authentication and collaborative multi-device authentication. In the former process multiple features or elements of the sound (e.g., characteristics of the sound such as frequency and intensity) are examined to authenticate the user. In the latter process multiple devices participate in the authentication process.

In one embodiment of the present invention, authentication is performed on a first device, while a second device (or devices) authorizes the transaction or executes the transaction. An “action code” may be related to a specific alias such as identifying an account associated with a specific alias and accessing that account. In one embodiment the action code is sent to a point of sale (POS) terminal where it is then routed to multiple devices for accessing a specific item, such as an account.

In one method of the present invention, a user may make a sound at a POS. If the POS authenticates the user, the terminal authorizes or executes a transaction or routes the user's input (keystrokes on a keypad for example) to a processing device where the transaction is executed.

In an embodiment using a sound as an alias, the sound may both identify the user for authentication (e.g., a device senses the sound, determines the person making the sound, and consults a list of authorized users to authenticate the user if her name appears on the list) and the sound interpreted to determine the nature of the transaction to be performed. According to other sound-directed transaction parameters the alias may include a specific dollar amount for a transaction or other specific information need to complete the transaction (such as the name or brand of a product that the user desires to purchase).

In embodiments where the alias is a sound, the model(s) supporting sound recognition may be present either remotely on a server or cloud, or locally on a device such as but not limited to a desktop, laptop, mobile or wearable device.

In some embodiments, acoustic recognition models may also be distributed to multiple devices that are inter-aware (e.g., each is aware of the other's presence and is capable and authenticated to transact with the other devices). In such a network, one device may “wake-up” other devices to participate in the acoustic recognition process. During recognition sounds may be distributed among devices in various ways including the distribution of raw sounds, sound elements, and feature sets based on the sounds or risk/confidence scores associated with the sounds. In some embodiments, each one of the distributed devices senses the sound, authenticates the user, and executes the transaction.

In other embodiments one device may perform certain specified actions while other devices may execute other actions. For example, multiple devices may sense the sound and authenticate a user, while another device performs the transaction. In still other embodiments, multiple devices may sense the sound, authenticate the user, and execute the transaction collaboratively.

In another embodiment, a device may be chosen to execute a payment based on the quality (e.g., numerical value) of the risk/confidence score produced by that device.

Risk/confidence scores may also be used to determine the accounts to which a user may be authenticated. Certain accounts (for example those having a higher asset balance) may require a lower risk score (i.e., a higher confidence in the proprietary of the authentication process) than those accounts with a lower asset value.

In one embodiment of the present invention, after user authentication, a device such as a smart wallet, or multiple devices such as a smart wallet and a phone, may be used to complete a financial transaction involving one account or multiple accounts. For example, access to each account may be available only through the device that authorized access to that account.

When conducting a transaction using multiple devices, after the user has been authenticated to each device and authorized to access accounts through those devices, specific asset amounts from each account may be retrieved by each device and these amounts combined to effectuate the transaction.

One method of the present invention uses a single device, such as a mobile phone, to recognize a sound and authenticate a user to access and complete a transaction. Hence, a single device can authenticate a user and authorize that user to make a payment (or conduct any transaction). This localized form of authentication and payment not only makes transactions simple, but more secure in that it is not necessary to send authentication or transaction data between devices.

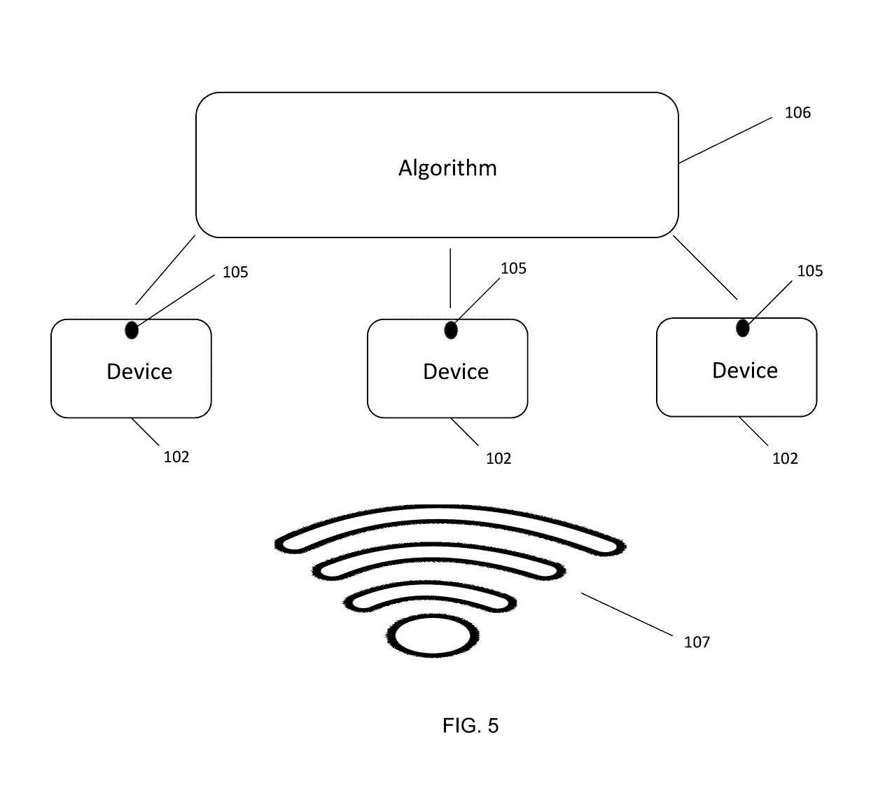

FIG. 5 shows how multiple devices 102 may be used for training one or more algorithms 106 that are used to validate the alias; the alias for use after validation in conjunction with the authentication process and/or with the transaction process. Each device 102 may contain one or more sensors 105 for receiving sound waves 107 or behavior information. Those familiar with the art recognize that multiple sensors 105 not only collect more information, increasing the accuracy of the recognition algorithms 106 or models, but also increase accuracy during the recognition process. When applied to a payment transaction, the use of multiple sensors may make the payment process more secure.

The devices 102 may include, but are not limited to, mobile devices such as cell phones, wearables such as smart watches or smart wallets or cloud-based devices such servers and the like. In addition to their use during the training phase, the multiple devices 102 (or any one of the devices 102) may utilize the algorithms 106 to authenticate the user and/or to identify the transaction.

Communications techniques between the devices may include, but not limited to, optical, acoustic, supersonic, Bluetooth, Bluetooth LE (Low Energy), ANT, BodyCom (a short range wireless connectivity technology), WiFi, NFC (Near Field Communication), cellular communications such as 3G/4G/LTE, RFID (Radio Frequency Identification) and/or other RF (Radio Frequency), acoustic and/or optical communications techniques, collectively called “communications” herein.

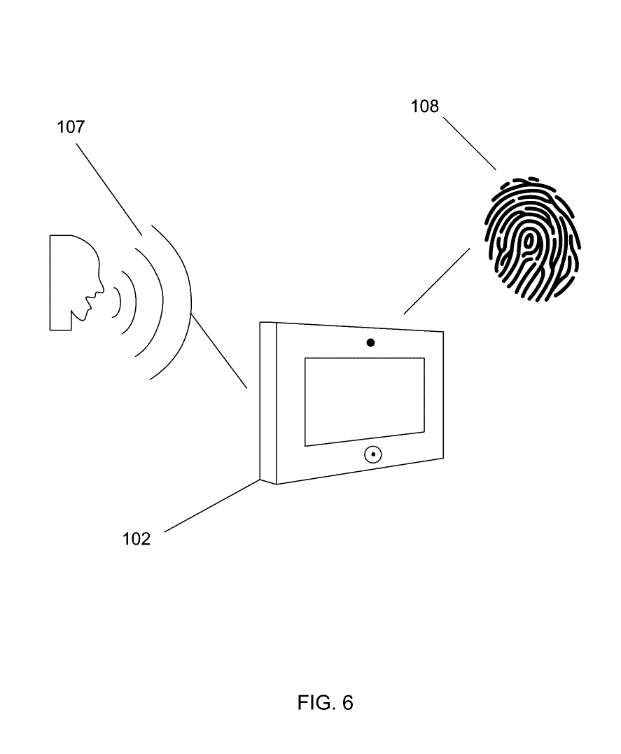

FIG. 6 illustrates an embodiment wherein sound recognition is performed on one of several factors required to authenticate a user or permit the user to gain access to one or more devices 102 to make a transaction. In this embodiment sound recognition is used in combination with other authentication factors 108 (a fingerprint in this non-limiting example) to improve security by improving the accuracy of the authentication process. For instance, sound 107 may be combined with a finger print 108, a PIN, or a code to improve security by increasing the number of factors required for authentication. In another embodiment, the use of multiple factors may be used to improve a risk score.

A non-limiting example of the use of multiple factors for authentication may include a smart wallet with sound recognition for authenticating the user and executing certain first actions, while prompting the user to enter a PIN for a different second action. Use of these two factors may permit execution of a transaction requiring a higher level of security, such as a financial transaction.

In other embodiments, the entry and/or analysis of these multiple factors may be spread across multiple devices. For instance, a sound recognized on a smart wallet may collaborate with a face recognition process carried out on a smart phone that can image and analyze the user's face. Examples of such collaboration are described and claimed in commonly-owned patent application entitled Distributed Method and System to Improve Collaborative Services Across Multiple Devices, filed on Feb. 8, 2016 and assigned application Ser. No. 15/018,496. This application is incorporated herein in its entirety.

In certain embodiments, a group of devices may be inter-aware, trusted and/or sharing certain information or data, which may require the devices to be in proximity with one another before the transaction is authorized. In yet other embodiments, multiple devices can make transactions through multiple accounts local to or shared between devices. Keeping all authentication credentials secured locally to one or more devices, the use of local recognition to execute transactions provides a more secure payment solution than passing information across insecure communications where it may be susceptible to interception.

In yet other embodiments, sound recognition is combined with proximity authentication before authenticating a transaction. Under this embodiment, one device may simply verify that one or more other devices are in close proximity for some period of time before authenticating a user or authorizing any transaction, thereby achieving a “proximity directed payment system”. In different embodiments, these devices may be mobile, portable, or wearable devices. In other embodiments, one or more specific and predetermined devices must be present before authentication, access, selection or authorization to a device, account, etc. can be achieved. In yet another embodiment, two or more devices must authenticate with each other, and/or a user, before any user authentication, access, selection or authorization can occur.

The present invention also comprises a “geographic-directed transaction” technique whereby a sound or behavior authentication process is used in combination with predefined or dynamically-determined geometric or geographical location limits (i.e., “fences”) to authenticate the user and/or authorize a transaction. In one embodiment, the user will be either granted (or denied) authentication and/or access based on his distance from a central geographical point. In another embodiment, the distance of the user from a geographical point can be incorporated into the risk or confidence score. In still another embodiment, the user must be within certain geographical areas (i.e., “fenced in areas”) to approve and/or deny payments.

The present invention also comprises “time-directed transaction” technique wherein a device utilizes a fixed time, a dynamically-determined time, or a time range in the authentication process or to determine security level for the transaction. In some “time-directed transaction” embodiments, a user's response time will affect the risk and/or confidence score. In still other embodiments, time limits can be adjusted relative to specified and appropriate risk/confidence score, and/or interactions that a user has with a time limit. In yet another embodiment, a transaction may be approved or denied based on the expected time duration of the transaction or the start time of the transaction.

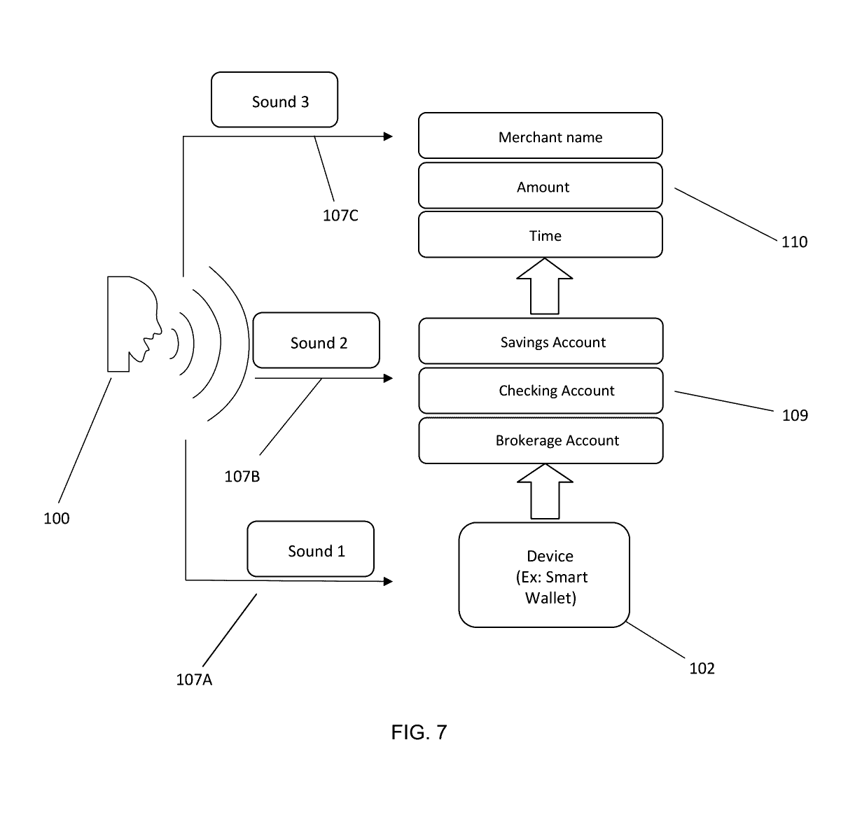

FIG. 7 illustrates a non-limiting example of how a source may direct a specific transaction by a sound that is correlated with that transaction. Each acoustic model or models may be associated with a specific transaction, such as but not limited to access to a physical area, access to a device, access to a website, access to elements of information, and selection and/or authorization to an account to direct a financial transaction, collectively referenced as “actions” herein. When a model recognizes the user's sound, the transaction associated with that model is executed.

In FIG. 7 sound 107A (sound 1) is associated with and authenticates the source 100 to access the device 102 if the sound 107A is recognized. Sound 1078 (sound 2) is associated with and authenticates the user to access accounts 109 if the sound 107B is recognized. Sound 107C (sound 3) is associated with and authenticates the user to access the account 110 to make a payment to a merchant associated with the account 110. Transaction parameters associated with the account 110 may include an amount to pay, an item to purchase, a name of a merchant, a time and/or date and/or day of the week for the transaction.

In another embodiment, a first sound or sounds may access the device (a smart-wallet), while a second sound may access a specific account accessible through the smart wallet. In yet another embodiment, a third sound may indicate approval for a specific transaction parameter, an amount for example. This “multi-sound transaction method” can be staggered with sounds spoken in series with and/or without a pause between sounds, and/or interactive; with one or more prompts for additional sounds from a device, thereby enhancing the security of the transaction.

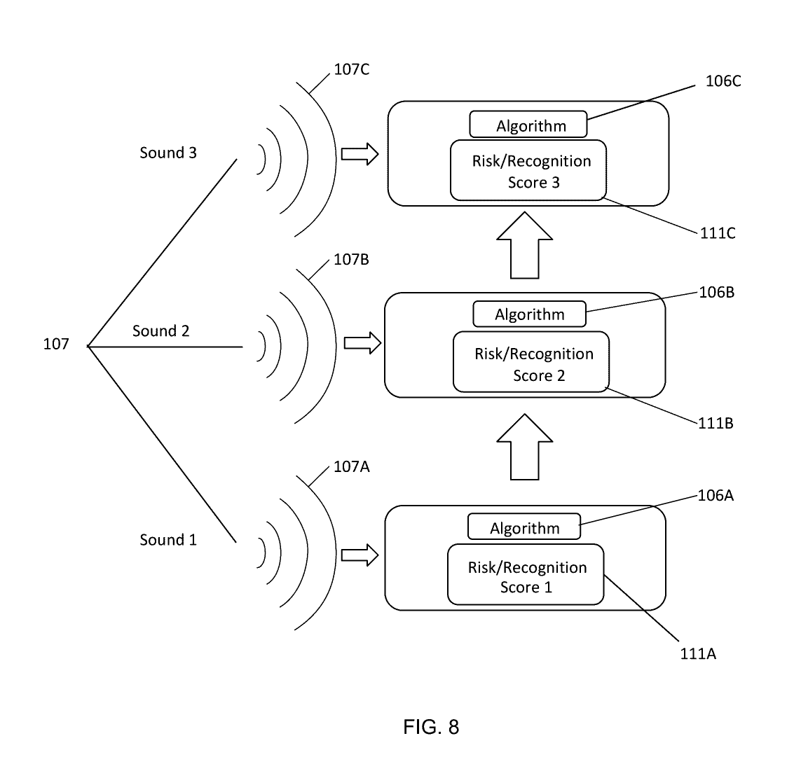

FIG. 8 illustrates yet another embodiment where multiple sounds 107A, 107B, and 107C are used in combination to achieve a higher level of security. A single user may generate each of the sounds 107A, 107B, and 107C. In lieu of analyzing the entire first sound 107A, features are extracted from the sound for processing through a recognition algorithm 106A. (This concept of extracting sound features and analyzing those features, in lieu of analyzing the entire sound may be applied to any of the sound recognition embodiments of the present invention.) This analysis produces a risk/recognition/confidence score 111A for use to authenticate the user or the score 111A can be incorporated into the algorithm 106B for recognition of the second sound 107B or features extracted from the second sound 107B. Once the second score 111B is produced, a third score 111C can also be produced using the second score 111 B and another sound recognition process as executed by the algorithm 106C.

In one embodiment each subsequent score 111A, 111B, and 111C uses the previous score to calculate the next risk/recognition/confidence score. As a result, security of accessing the one or more devices, accounts, or locations is increased due to the use of a cumulative score.

Of course in yet another embodiment each score can be used independently or combined with the other scores in any manner to develop the final cumulative risk/recognition/confidence score.

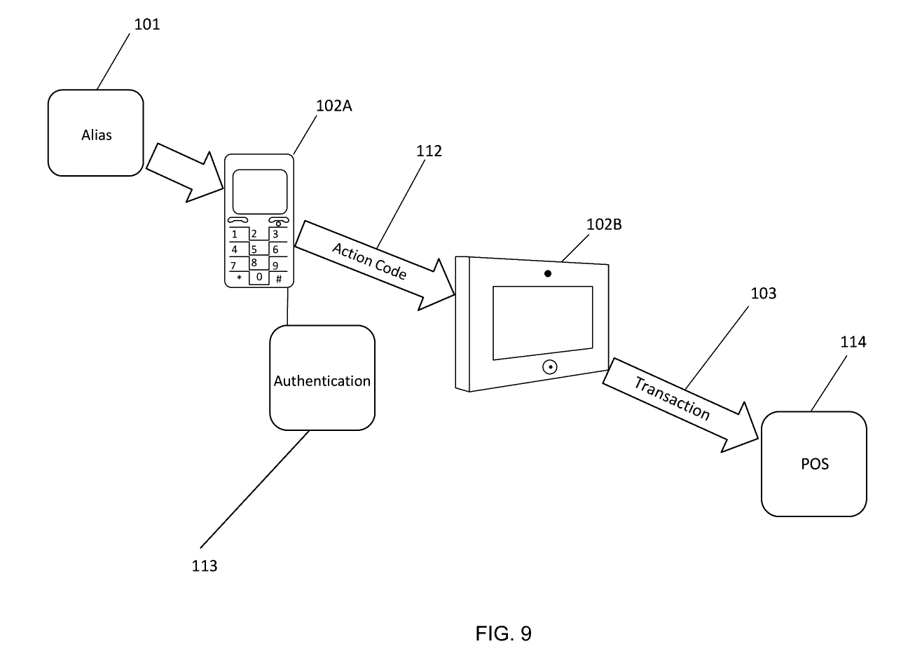

FIG. 9 illustrates one embodiment a transaction. such as account selection and/or user authentication 113, may be performed by a first device 102A, while a transaction, such as a transaction 103 may be performed on a second device 102B. In the illustrated application the transaction 103 is executed on a POS terminal 114.

In various embodiments of the invention sound may be associated with another parameter such as but not limited to one or more payment card brands, aliases, or a code referenced collectively as “action codes” herein. Brands may include but are not limited to payment companies such as but not limited to “Visa” or “MasterCard” or any other company such as “Wal-Mart” as in the case with a gift card. In one embodiment the action code 112 is a dynamic code, such as an OTP (One-Time-Passcode), token and/or dynamic pairing code, recognized by the second device 102B as associated with a specific account.

In one embodiment, processing the first sound, the first action, or the first behavior facilitates generation of a cryptogram or token associated with at least part of the transaction information. Tokens may be generated by 3^{rd} party applets, or may, in some embodiments, be generated from keys and/or applets (small software applications) within the device. In one embodiment, aspects of the sound or behavior may be used in the generation of the token or cryptogram.

The use of action codes is useful in applications where a user may wish to choose a transaction, such as one or more accounts to make a payment, on a first device 102A, (a cell phone, for example), while actually performing the transaction on a second device 102B, (a smart-wallet, for example) without compromising any account information.

In any of the described embodiments, an alias may represent an action code to further enhance security as actions such as payments are directed from one or more devices to be executed on one or more other devices. For instance, a user may use an alias to select a gasoline credit card for payment. In another example a user speaks the phrase, “grocery card number 3.” For both of these examples the alias may be recognized and an associated action code sent by the authenticating device, such as a phone, to a second device, such as a smart-wallet, where the account associated with the alias is selected for payment.

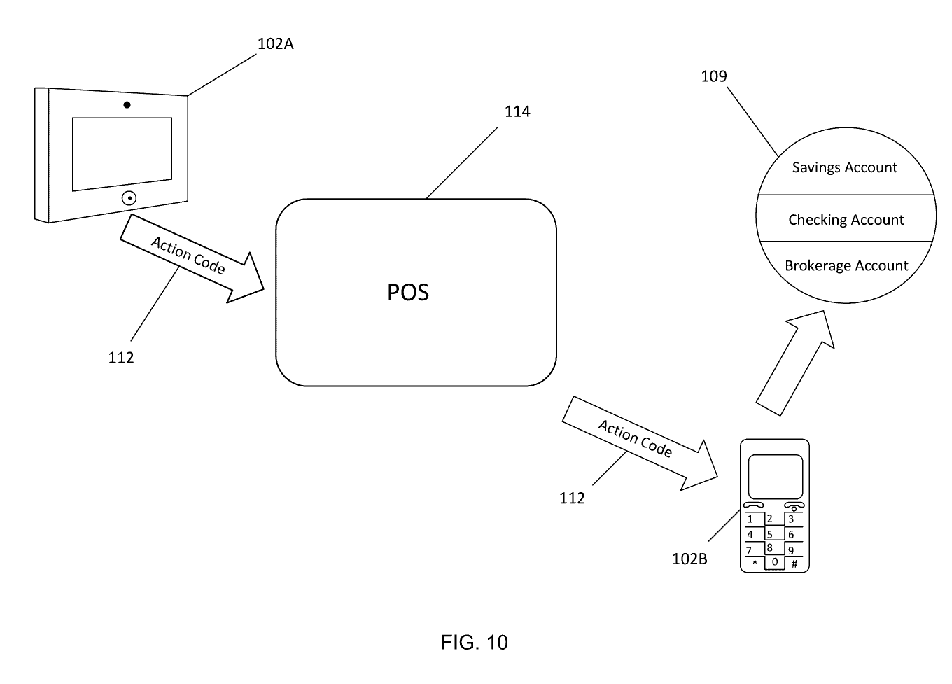

FIG. 10 illustrates an example of sending an action code 112 from a device 102A to one (or more) point of sale terminals (POS) 114, from which the action code 112 is routed to one (or more) device 102B that recognize the code 112 as associated to one (or more) specified account 109. This method protects all account information as it is passed from the device 102A to the device 102B. The user can select one of the accounts 109 by generating a sound or speaking a word or phrase associated with an action code that identifies that account.

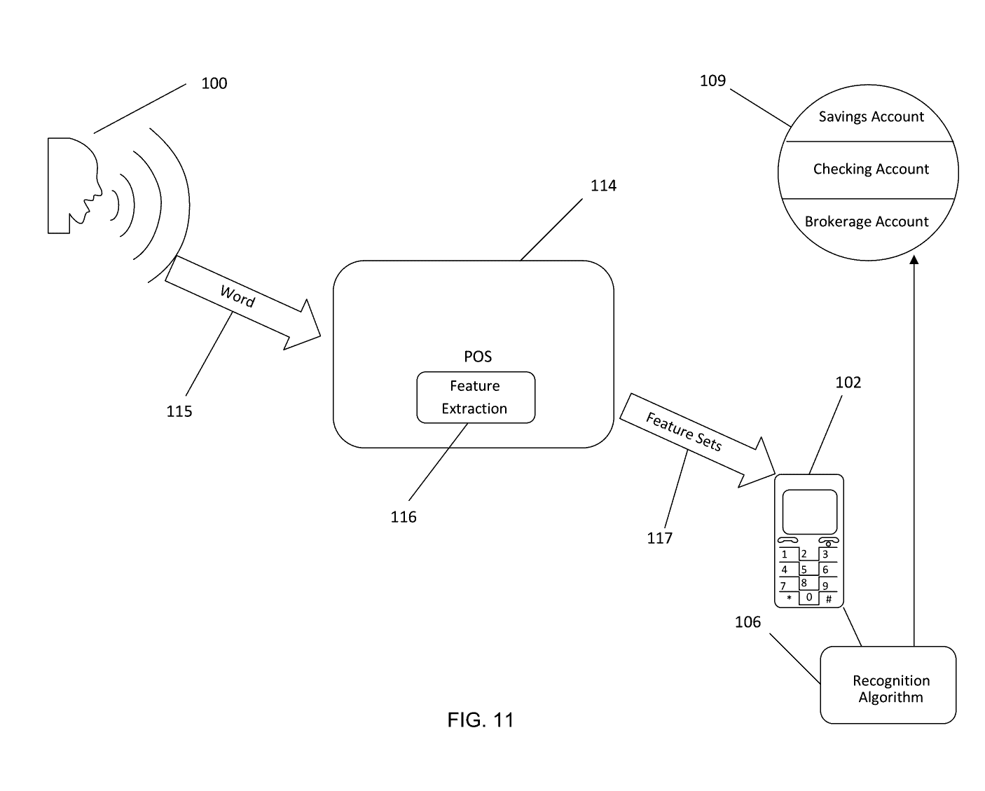

FIG. 11 illustrates an embodiment in which a source 100 approaches a POS terminal 114 and speaks a word or phrase 115 to select an account 109. In this embodiment, one or more microphones (not separately illustrated) on the POS 114 collect the vocal vibrations or features associated therewith 117 as extracted by an extraction feature device 116. The set of extracted features 117 is sent to a remote device 102 (and/or a service) that recognizes the word phrase 115 (using a recognition algorithm 106) and selects the desired account 109 associated with that word or phrase.

Just as with local sound recognition described elsewhere herein, one or more remote acoustic recognition models may recognize the word or phrase 115 as well as the speaker 100, thereby achieving a remote 2-factor voice directed payment solution. However, a disadvantage of this embodiment is the necessity to store the user's biometric data and/or alias remotely, where the biometric data can be obtained by a third party device beyond control of the user, that is, the owner of the biometric data.

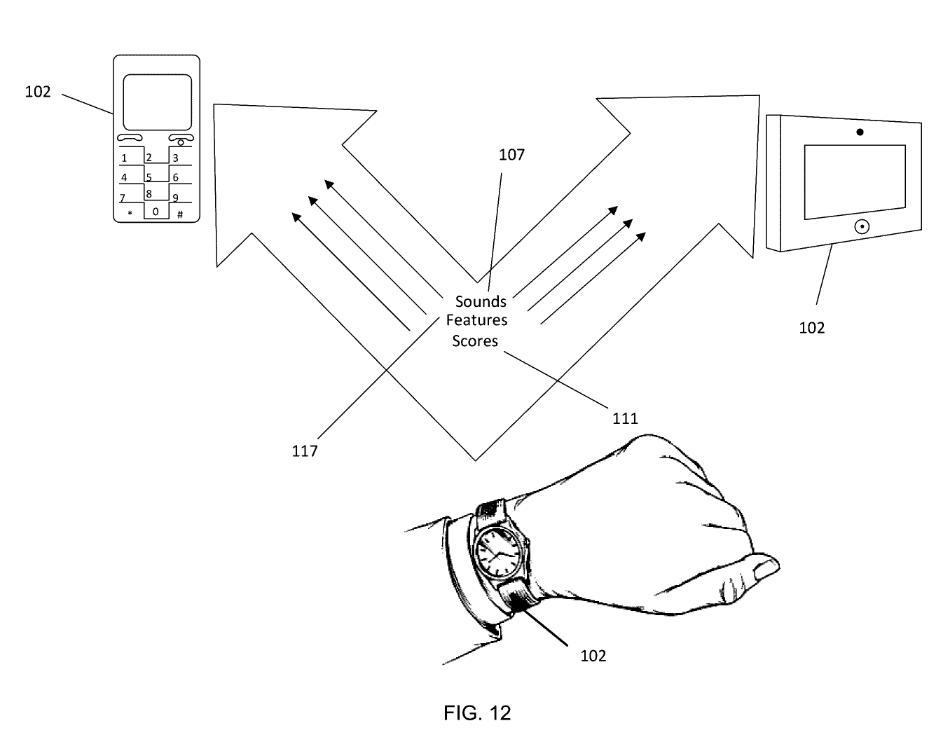

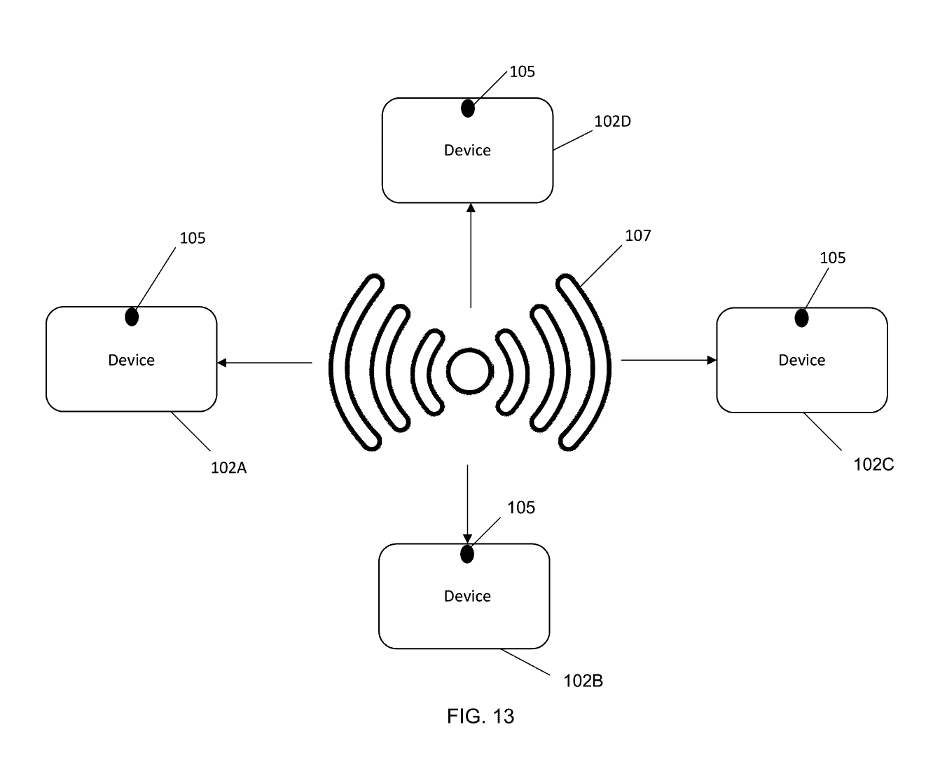

FIG. 12 and FIG. 13 show non-limiting examples of devices that collaborate with other devices and are said to be “inter-aware”. In certain embodiments inter-aware devices may perform such services including but not limited to collective training, adaptive sound recognition module updates, signal quality improvement, collaborative sound recognition, and/or fusion of voice recognition scores, all referenced herein as “collaborative services”. In these embodiments the algorithms and acoustic models are housed within multiple devices 102, or a network of devices 102. The devices may include mobile devices, cloud-based devices, servers, and/or any combination of these and other known devices.

Sounds 107, features 117 extracted from the sounds, and/or scores 111 derived from the sounds 107 or features 117 are supplied to or determined by a device 102 as shown in FIG. 12. One or more of these elements collected from one or more devices are distributed to other ones of the collaborative devices according to any one of many known data distribution techniques.

Alternatively, the sounds 107 or gestures may be received simultaneously by each device 102A, 102B, 102C and 102D in an embodiment where each of the devices comprises microphones 105 or other acoustic sensors within range of sounds 107. See FIG. 13. To accomplish this, the devices each must be within an appropriate range of the sound. In one embodiment, once the sound is received at each device, each device can perform complete sound recognition and authentication process. Each device can then perform the authorization and execution of the specified transaction locally (if the transaction can be accomplished locally) or one or more of the devices can send a code to one or more of the other devices authorizing the receiving device to execute the transaction.

In one example, feature sets are extracted by one or more of the devices 102A, 102B, 102C, and 102D and then sent to the other ones of the devices 102A, 102B, 102C, and 102D. The receiving devices perform sound recognition using the feature sets and one or more sound recognition algorithms. Risk/recognition/confidence scores can be run against one or more models that are either shared or unique to a single device.

One embodiment comprises a technique where a single device produces a recognition score and this score is distributed among multiple other devices for authentication and authorization. Authentication and/or authorization permits granting access to a device or to information stored on a device, such as financial accounts on the device.

In still another embodiment, one or more of the devices may be selected to execute a transaction based on the quality of the recognition scores produced by the devices. For example, if the device 102A has a lower risk score than another device 102B, then the device 102A will execute the transaction.

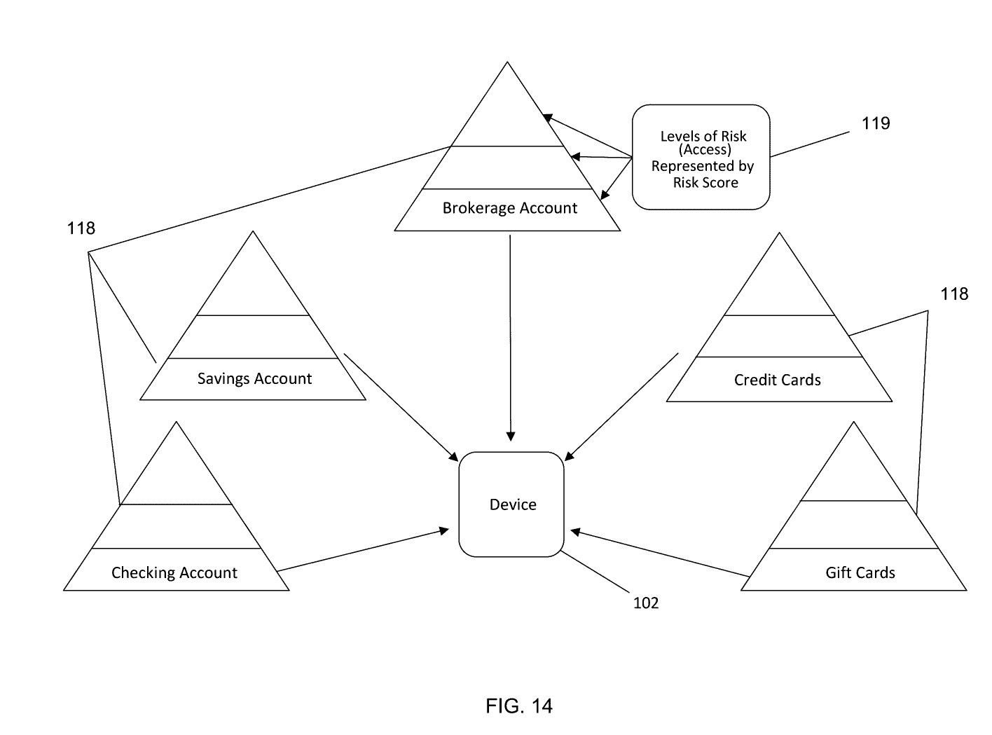

FIG. 14 illustrates another embodiment of the present invention that entails methods and devices where one or more devices 102 (only one device 102 illustrated) use sound recognition to complete a transaction for one or more accounts 118 accessible to the one or more devices 102. Each device 102 can be associated with the one or more accounts. In a non-limiting example, the devices 102 perform recognition then one or more devices 102 execute the transaction on the one or more accounts 118. This embodiment is hereafter referred to as “asset bases.”

In a sense the transaction is executed by “grabbing” assets from each asset base 118 to execute a single transaction. These asset bases 118 include but are not limited to bank accounts, brokerage accounts, credit cards, debit cards, gift cards, prepaid cards and/or checking accounts. Each device 102, upon authentication, is given access to one or more asset bases 118 that are either exclusive to a single device or are shared among devices. In one embodiment of the present invention different asset amounts (dollars) can be extracted from each account 118 based on the risk score 119 generated for each device 102. Each risk score 119 relates the risk level of accessing a specific account or an amount in the account based on the recognition and authentication of the user, upon which the risk score 119 is based.

One embodiment of the present invention utilizes a technique to reject the access to an asset base via a device if the risk score 119 is too high or the confidence/recognition score is too low. This concept of rejecting asset bases is herein referred to as “asset base rejections.” In one embodiment of the present invention, base rejections can be incorporated into the algorithm in order to calculate future risk scores 119.

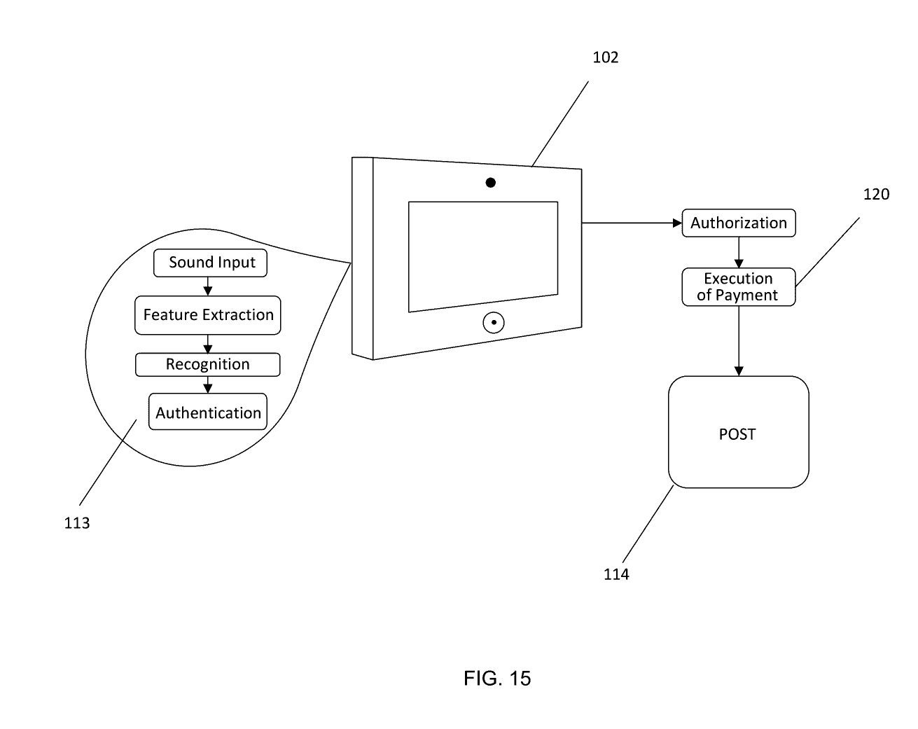

FIG. 15 shows yet another embodiment, a single device 102 including but not limited to a cell phone, smart wallet, or server performs both recognition of the user and the authorization and execution of a transaction 120. The device 102 may have one or models to carry out authentication 113. Such models can be used in combination with one another to produce a more accurate authentication. Once a successful authentication has occurred, a user may choose from multiple accounts within a device by speaking or making a specific sound that is correlated with one or more of the accounts.

In another embodiment the transaction is executed on a POS 114 instead of executing on the device 102.

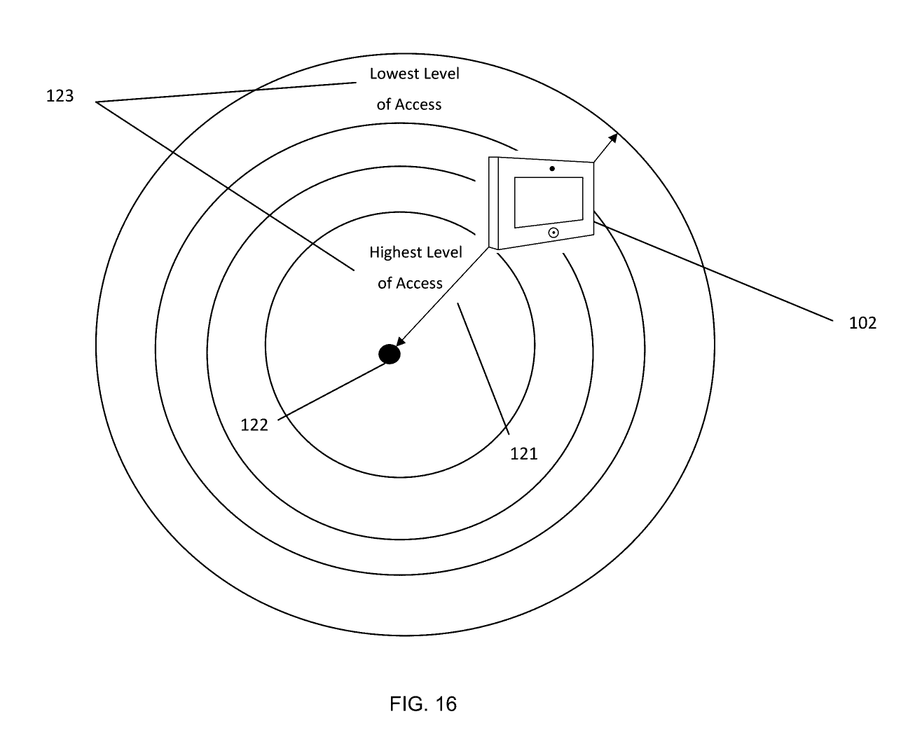

FIG. 16 illustrates another embodiment of the present invention wherein access of an account is regulated not only by sound input, but also by location, which will hereafter be referred to as a “geographical limit” or “fences.” The geographical limit 121 can include but is not limited to a radius from a geographical center point 122 or a distance from a certain location. The farther the user and/or device is from the specified location the lower level of access the user is granted. Levels of access are indicated in FIG. 16 by reference numeral 123. As a result of this lower access level, the device 102 will not be permitted to access accounts (or segments of accounts) having a higher-level of security. For example, a transaction amount (number of dollars, for example) may be limited by the level of access based on distance from the center point 122 or another defined location.

In yet another embodiment, the user must be within certain geographical areas or zones to approve a transaction. These “fences” may be any shape or size, utilizing some geographic measuring capability to determine the whereabouts of the device and/or user and thereby determine if the user is within the desired area or zone. Geographic sensing can be accomplished GPS (Geographic Positioning System)-based, triangulation method that utilizes position of multiple devices to triangulate position, and/or other methods that utilize RF such as but not limited to RFDOA (Radio Frequency Difference of Arrival), TDOA (Time Difference of Arrival), Doppler and the like. In some instances, one or more devices, such as a cell phone, may provide one or more other devices, such as a smart wallet, its location via some communication between the two devices.

In another embodiment of the present invention, the location of the user can be incorporated into a risk score for accessing a specific account, a segment of an account, or for determining a dollar value limit for the account transaction.

In yet another embodiment, each account is assigned a required risk score or recognition/confidence score that must be met by the user to access that account. These required scores can be static or dynamic. Dynamic scores can be changed each time the account is accessed or each time access is attempted, for example. As the account is accessed more times the required risk score is decreased while the required recognition score is increased. The fewer times that an account is accessed, the required risk score is increased and the required recognition score is decreased.

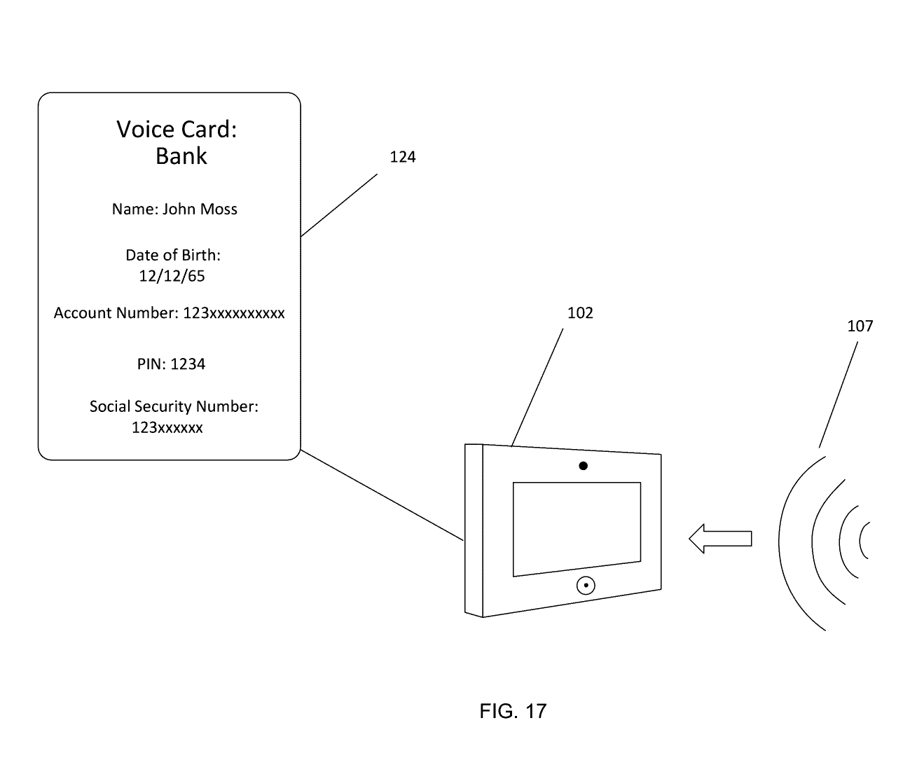

As the risk score increases the user's level of access (see reference numeral 123 in FIG. 17) decreases. Likewise, as the recognition/confidence score increases the user's level of access increases. In the event that a risk score decreases, a device or user may request further authentication factors to be entered and/or sensed to thereby improve the risk score.

One embodiment of the present invention uses a method wherein time is a limiting security requirement. Either fixed or variable, the time limit, in combination with action or sound recognition can be used to further secure such items such as, but not limited to, accounts, devices, or places. In one non-limiting example, the user may be asked to enter a sound input and then fail to enter the correct sound input, or the user may not enter anything. Such attempts will hereafter be referred to as “failed attempts” and “non-attempts,” respectively. If the user fails to respond within a required time, then the user will be asked for additional information. Such additional information may include additional sound input, biometric information, or a PIN. Embodiments that utilize time as a factor in account and/or payment access, selection and/or authorization are called “time directed payments”.

In certain embodiments, if a user fails to respond with either the correct information, or the time limit is exceeded and no additional information is provided, the failed attempt or non-attempt is incorporated into the risk and recognition/confidence scores as determined by the applicable algorithm. The more failed attempts or non-attempts that are detected, the higher the risk score and the lower the recognition score. As a result, as the user uses more time to unlock an item such as an account, the lower are his chance of successfully accessing the account later, thereby increasing the security associated with the account to thwart potential unauthorized access.

In another embodiment, a variable time limit is affected either by failed or non-attempts. In one non-limiting example, if a failed or non-attempt occurs, the time limit to enter the desired input will decrease as determined by the failed attempt or non-attempt. In another embodiment, the time limit decreases as directed by an increase in either or both of the risk and recognition/confidence scores as a result of the failed attempt and/or non-attempts. The user will then have less time to enter the required input.

In yet another embodiment, a wait time may be imposed on the user if either a failed attempt or a non-attempt occurs. The wait time may also be directed by an increase in the risk score or a decrease in the recognition score. The user will then have to wait a time interval before another input can be made.

In still another embodiment, a time limit can be incorporated during recognition and authentication. In some “time-directed payment” embodiments, a user's response time will affect the risk and/or recognition scores. As a non-limiting example, a device may increase the risk score by the amount of time lapsed if the user's input was not received within the time limit. The input may be rejected and a new user input may be requested by the device or other devices or other devices when operating collaboratively. The time window for a user input could also decrease based on the number of times that the user fails to meet the input-time requirement. In one embodiment, the delay of the user input could also be incorporated into the one or more authentication models for producing proceeding risk scores. In still other embodiments, time limits may be adjusted relative to the specified, appropriate scores, and/or interactions that a user has with a time limit.

Parts of music and/or tunes, melodies, whistles and the like, hereafter referenced as “tunes”, may also be used to provide a “tune payment method”. Here, access to a device, an application and/or an account. Under this embodiment, one or more devices may recognize the music or “tune”, and direct the appropriate user-programmed transaction and/or alias associated with that tune either individually or collaboratively. Under another embodiment, the tune may be combined with other authentication factors (a PIN or pattern, for example) to improve security. In yet another embodiment, the tune may be modulated with other signal information and/or data that is also passed when the tune is transmitted.

FIG. 17 illustrates another embodiment of the present invention: a method to store and retrieve information using various sounds 107, including but not limited to voice commands, is sensed by one or more devices 102. Such information correlated to a specified sound 107 is herein referred to as a “voice card” 124, and exemplary components are illustrated in FIG. 17.

In yet another embodiment, the user can access the voice card 124 using only the sound 107 or by a combination of different factors in combination with sound. These factors can include but are not limited to biometric factors such as a fingerprint, or a non-biometric factor such as a PIN.

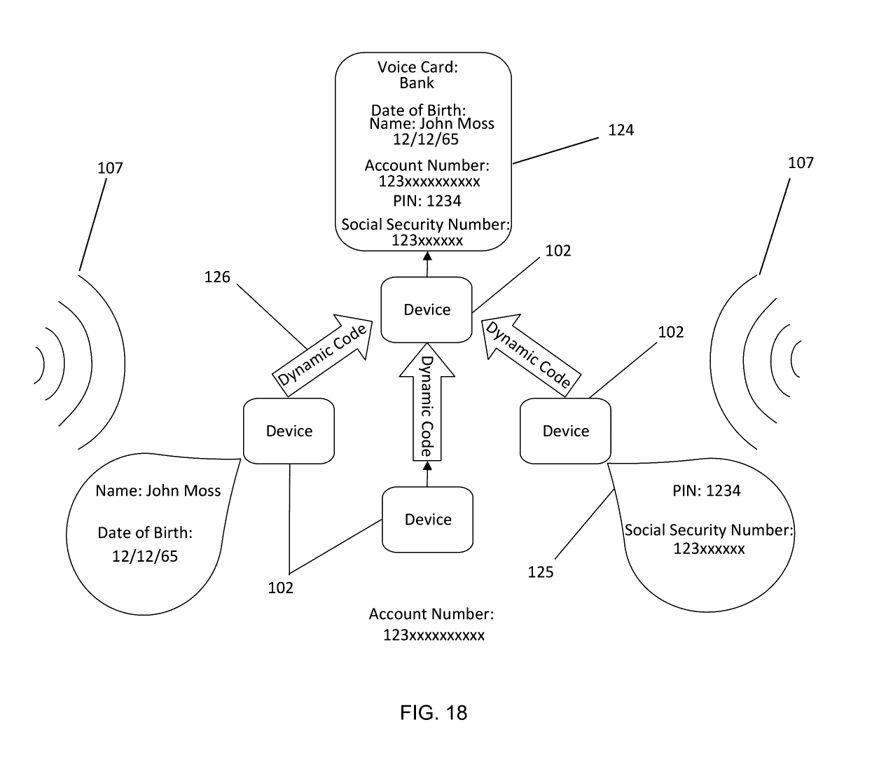

FIG. 18 illustrates an embodiment of the present invention relating to voice cards 124 and information components 125 that can be stored on the voice card 124. Information comprising a single voice card 124 may be stored and accessed from two or more devices 102, upon successful recognition of the user by both devices. In one example, the recognition process uses one or more sounds 107 that are entered either simultaneously or at intervals. Upon successful recognition, the user may access each information component 125.

Recognition can be achieved according to any of the techniques described herein. For example, the two or more devices 102 must be within a predetermined range to both receive the one or more sounds 107. After one or more of the devices 102 recognizes the user, each information component 125 stored on that device may be provided to the authenticated user.

Alternatively, one of the devices 102 may be considered the “central” device and all voice card components are sent to that device for assembling the complete voice card. Each information component may be sent in a form including but not limited to a dynamic code 126 that is created by one or more algorithms on the devices 102.

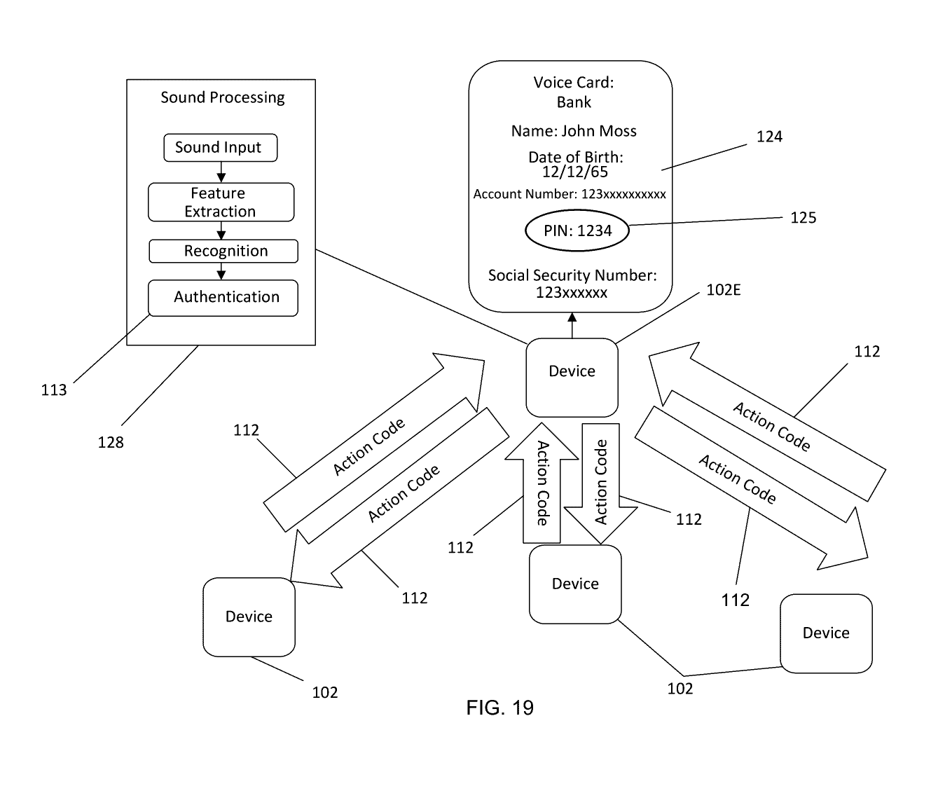

FIG. 19 illustrates an embodiment of the present invention relating to voice cards 124 and information components 125 that can be stored on the voice card 124. Information comprising a single voice card 124 may be stored and accessed from two or more devices 102, upon successful recognition of the source by both devices. In one example, the recognition process uses one or more sounds 107 that are entered either simultaneously or at intervals. Upon successful recognition, the user may access each information component 125.

Recognition can be achieved according to any of the techniques described herein. For example, the two or more devices 127 must be within a predetermined range to both receive the one or more sounds 107. After one or more of the devices 127 recognizes the user, each information component 125 stored on that device may be provided to the authenticated user.

Alternatively, one of the devices 102E may be considered the “central” device and all voice card components are sent to that device for assembling the complete voice card. Each information component may be sent in a form including but not limited to a dynamic code 126 that is created by one or more algorithms on the devices 102.

FIG. 19 also illustrates an example wherein a complete voice card 124 is stored on a single, central device 102E during an access attempt. However, after successful sound processing 128 and authentication 113, the central device 102E does not have access to the one or more information components 125. The device 102E sends an action code 112 to one or more secondary devices 102 requesting authorization to the information components. If anyone of the one or more secondary devices 102 recognizes the action code 112, then these secondary devices 102 reply with an action code 112 to the central device 102E authorizing access to the information component 125. In one embodiment, each secondary device 102 authorizes access by the central device 102 to a single information component. In other embodiments, access to multiple information components 125 or access to the entire voice card 124 may be granted by one or more of the secondary devices 102. This “distributed voice card” technique of distributing information across multiple devices thwarts theft of the information from loss.

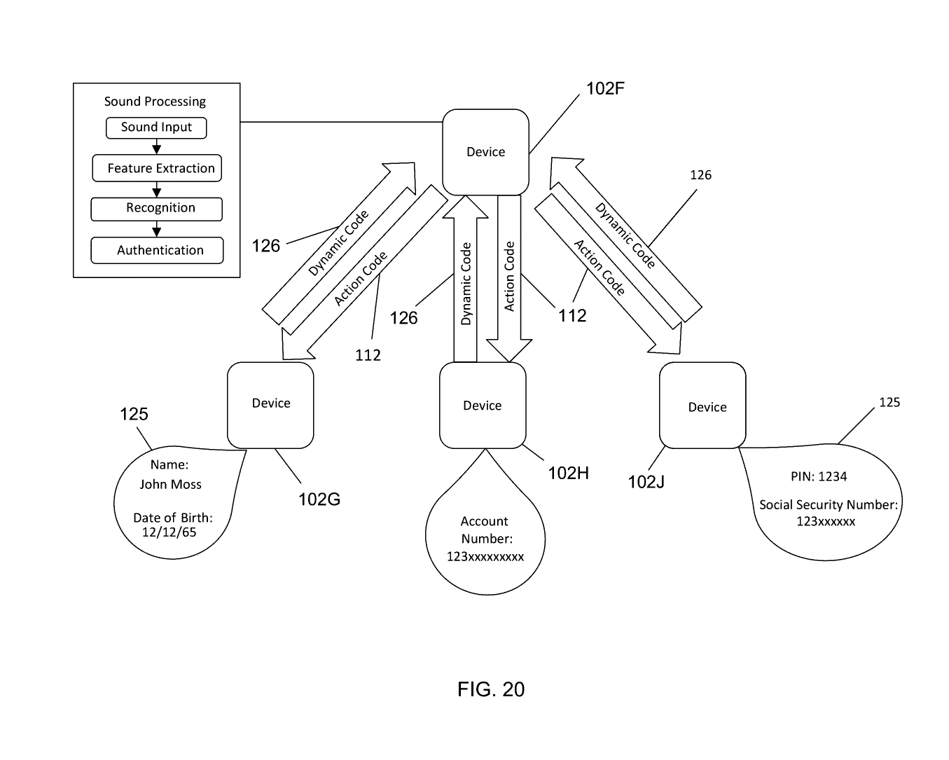

FIG. 20 illustrates an embodiment of the present invention consisting of method and/or system wherein one or more sound inputs are received and authenticated by a single device 102F, which then accesses information components 125 located on one or more other devices 102G, 102H or 102J. Performing recognition and authentication of the user, this single device 102F sends out an action code 112 to one or more devices 102G. 102H, and 102J granting authorization to each such device to access one or more information components 125 located on the one or more devices 102G, 102H, and 102J. One or more of the devices 102G, 102H, and 102J sends back the requested information component in a form including but not limited to a dynamic code 126 generated by one or more algorithms local to the one or more devices 102G, 102H, and 102J.

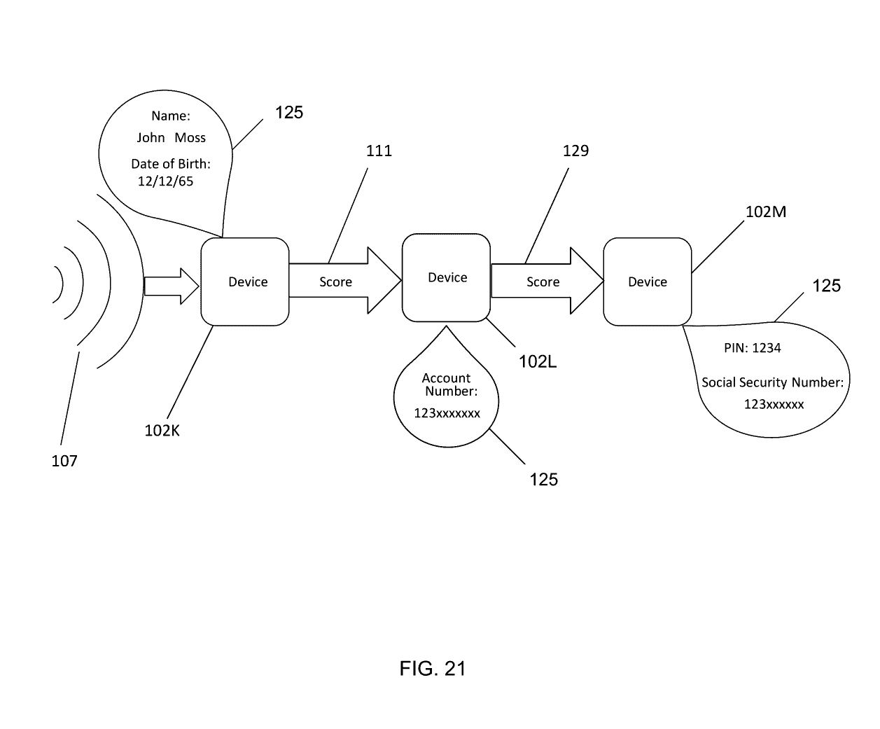

FIG. 21 illustrates yet another embodiment: a risk and/or a recognition/confidence score 111 may be incorporated into a subsidiary score 129 to authenticate one or more information components 125 from one or more voice cards that are located on one or more devices 102K, 102L, and 102M. In one embodiment, sound inputs 107 may be used singularly or in combination with one or more other authentication factors, to produce scores 111. After the score 111 has been generated within the device 102K, it can then be incorporated into one or more algorithms housed within the device 102L to generate a composite score 129. Repeating this process, each previously calculated score is incorporated into the one or more subsequent scores. Thus upon the input of a sound 107 by a user, a “score chain” is created wherein current scores affect future scores. Each of these “chained” scores will have a different value and thus permit access to accounts, devices, etc, with different levels of security.

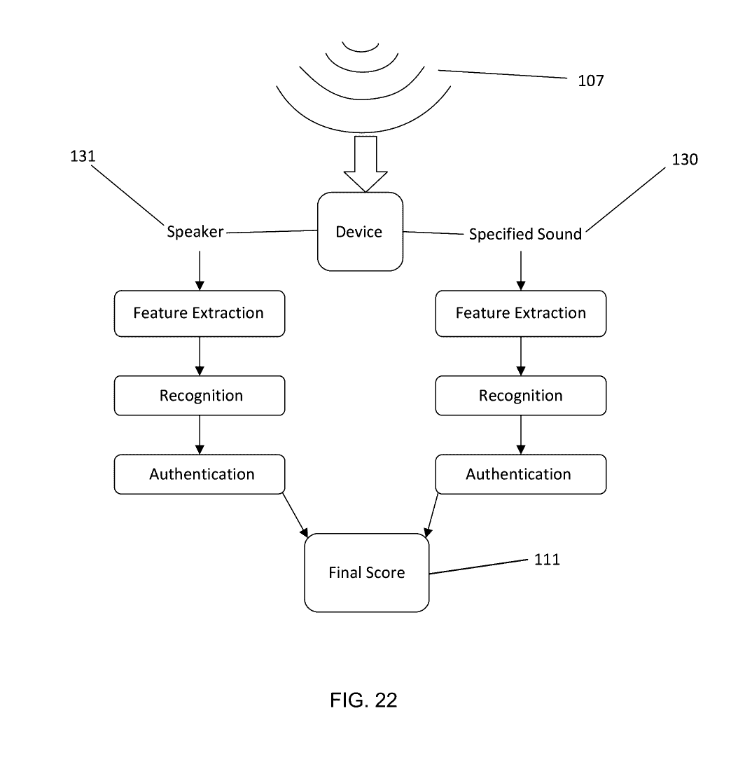

FIG. 22 illustrates a non-limiting example wherein for speaker dependent models, voice recognition may be considered a multi-factor analysis, since the speaker 131, the environment, and the specific sound or sounds 130 may be recognized and both analyzed. In one embodiment, one or more acoustic recognition models may recognize either the speaker 131 or the specific sound 130. In other embodiments, both the speaker 131 and the specific sound 130 are recognized, achieving a two-factor authentication based on only a single sound 107. In yet another embodiment, the one or more recognition models recognize the speaker 131, the specific sound 130, and the environment, achieving three-factor authentication. Those versed in the art will recognize that by training one or more given models in a given environment, various characteristics such background sounds, may be incorporated into the one or more feature sets for the further recognition of sound inputs such environments. Upon recognition, each input may be used to produce different risk and/or recognition/confidence scores and a final score 111 based on a combination of the two authentication scores. In yet another embodiment, scores produced from different variables of the sound 107 input may be combined into a single risk and/or recognition/confidence score 111.

Financial accounts referred to herein may include any deposit of money or other items of value, e.g., securities, with a holder, such as but not limited to checking, savings, brokerage, IRA, 401k, retirement, pension, health savings accounts, and insurance accounts.

Embodiments are described with reference to the attached figures, wherein like reference numerals are used throughout the figures to designate similar or equivalent elements. The figures are not drawn to scale and they are provided merely to illustrate aspects disclosed herein. Several disclosed aspects are described herein with reference to example applications for illustration only. It should be understood that numerous specific details, relationships, and methods are set forth to provide a full understanding of the embodiments disclosed herein. One having ordinary skill in the relevant art will readily recognize that the disclosed embodiments can be practiced without one or more of the specific details or with other methods. In other instances, well-known structures or operations are not shown in detail to avoid obscuring aspects disclosed herein. Disclosed embodiments are not limited by the illustrated ordering of acts or events, as some acts may occur in different orders and/or concurrently with other acts or events. Furthermore, not all illustrated acts or events are required to implement a methodology in accordance with the embodiments. All examples and exemplary alternatives set forth in the application are merely for illustration and are intended as non-limiting examples and alternatives.

What is claimed is:

1. A method for executing a transaction, comprising:
at a first processing device:
receiving a first sound, a first action, or a first behavior from a source;
processing one or more of the first sound, the first action, and the first behavior to identify the transaction; and
executing the transaction on the first processing device or a second processing device.

2. The method of claim 1 wherein the first processing device comprises a computer, a wearable, a mobile device, a portable device, a smart phone, a smart wallet, a smart card, a watch, a jewelry item, a key chain, an accessory, an e-book reader; a music player, or an electronic device having computer-processing or instruction-processing capabilities.

3. The method of claim 1 further comprising:
processing one or more of the first sound, the first action, and the first behavior to identify the source;
after identifying the source, determining whether the source is authorized; and
executing the transaction if the source is an authorized source.

4. The method of claim 3 wherein the step of determining whether the source is an authorized source comprises one or more of comparing the first sound to a predetermined trained sound, comparing the first action to a predetermined trained action, and comparing the first behavior to a predetermined behavior, and determining the source is an authorized source responsive to the step of comparing.

5. The method of claim 3 wherein the step of processing one or more of the first sound, the first action, and the first behavior to identify the source, further comprises processing the first sound, the first action, or the first behavior at a plurality device to identify the source, wherein each one of the plurality of devices analyzes the first sound, the first action, the first behavior, one or more elements of the first sound, or one or more elements of the first action, or one or more elements of the first behavior.

6. The method of claim 3 wherein the step of processing one or more of the first sound, the first action, and the first behavior to identify the source further comprises determining a score responsive to a degree of certainty associated with processing one or more of the first sound, the first action and the first behavior to identify the source, and wherein the score is used in conjunction with the step of executing the transaction.

7. The method of claim 1 wherein the step of executing the transaction is conducted at the first processing device or at a remote processing device responsive to information provided to the remote processing device by the first processing device.

8. The method of claim 1 wherein one or more of the first sound, the first action, and the first behavior operates as an alias associated with the transaction and the step of processing one or more of the first sound, the first action, and the first behavior to identify the transaction further comprises processing the alias to identify the transaction.

9. The method of claim 3 wherein the step of processing one or more of the first sound, the first action, and the first behavior to identify the source further comprises processing the first sound through a speaker-dependent acoustic model to identify the source.

10. The method of claim 1 further comprising receiving one or more of a second sound, a second action, and a second behavior from the source, and wherein the step of processing one or more of the first sound, the first action, and the first behavior to identify the transaction further comprises processing one or more of the second sound, the second action, and the second behavior in lieu of or in addition to the first sound, the first action, and the first behavior to identify the transaction.

11. The method of claim 1 wherein the transaction comprises a financial transaction, a purchase transaction, a telephone call, a payment transaction, retrieving a map, a financial exchange, or a reward transaction.

12. The method of claim 1 wherein the first sound comprises a vibration disturbance that generates pressure waves through a medium, the waves having an auditory effect upon reaching a sound receiver, and the first action or the first behavior comprises any one of a gesture, movement, or position of a user's hand, arm, body, head, face, or finger.

13. The method of claim 1 wherein the first sound is generated by a sound-producing device under control of the source.

14. The method of claim 1 wherein the step of processing one or more of the first sound, the first action, and the first behavior to identify the transaction further comprises processing the first sound through a speaker-independent acoustic model to identify the transaction.

15. The method of claim 3 further comprising a second device in close proximity to the first device for a predetermined period of time before executing the transaction or before determining whether the source is an authorized source.

16. The method of claim 3 wherein the first sound, the first action, or the first behavior comprises one or more numbers or one or more letters for comparing with respective one or more numbers or one or more letters to identify the transaction, to identify details related to the transaction, or to authorize the source.

17. The method of claim 3 further comprising executing one or more of a sound, an action and a behavior authentication process in combination with predefined or dynamically-determined geometric or geographical limits to identify the transaction, to identify details related to the transaction, or to authorize the source.

18. The method of claim 1 wherein processing one or more of the first sound, the first action, and the first behavior to identify the transaction comprises selecting the transaction from a list of multiple transactions and executing a selected transaction.

19. The method of claim 1 wherein processing one or more of the first sound, the first action, and the first behavior further comprises generating a cryptogram or token associated with at least part of the details related to the transaction.

20. A method for executing a transaction, comprising:
at a first processing device:
sensing a sound, an action, or a behavior from a source;
receiving identification information from the source, wherein the identification information may be an element of the sound, the action, or the behavior;
processing one or more of the sound, the action, and the behavior and the identification information to identify the transaction and to identify the source;
after identifying the source, determining whether the source is an authorized source; and
executing the transaction if the source is an authorized source.
